(19) United States
(12) Patent Application Publication
(10) Pub. No.: US 2022/0018691 A1
(43) Pub. Date: Jan. 20, 2022

(54) A HOUSING

(71) Applicant: Newscastle City Council, Newcastle West (AU)

(72) Inventors: Josh JEFFRESS, Gateshead (AU); Mat DOWMAN, Gateshead (AU); Adam CLARKE, Newcastle West (AU)

(21) Appl. No.: 17/309,544

(22) PCT Filed: Dec. 5, 2019
(86) PCT No.: PCT/AU2019/051331

§ 371 Date: Jun. 4, 2021

(30) Foreign Application Priority Data
Dec. 6, 2018 (AU) 2018904633

(51) Int. Cl. G01D 11/24; H04Q 9/00

(52) U.S. Cl. CPC G01D 11/245; H04Q 9/00

(57) ABSTRACT

In an embodiment of the invention, there is provided a housing for a sensor array comprising: a mounting plate for mounting the housing to a surface; a cover attachable to the mounting plate, where the mounting plate and the cover are shaped to form an internal cavity within the housing; a sensor array contained within the internal cavity; and at least one air pathway in connection with the sensor array to enable air to pass from outside the housing to the sensor array.

### TECHNICAL FIELD

The present invention is directed to a housing for a sensor array and a deployment system for the sensor array.

### BACKGROUND

In the past, scientific data was collected by hand or by individual sensor units placed around an area of interest. Commonly, sensor units placed in the area of interest require a clear space around them so that the sensor unit readings are not biased by any objects, structures or contaminants. For example, gas sensors require access to air flow in order to gain an acceptable data reading. However, many sensors are complex electronic devices that are sensitive to environmental damage, such as sun and water damage. Therefore, due to the requirement of clear space, the sensors are usually unable to be effectively shielded from the environment and weather conditions. Due to the exposed positions of these sensors, they typically experience wear and tear at an advanced rate.

Moreover, the mountings that secure the sensors need to be secure so that the sensor units do not become displaced, for instance, during high winds. Accordingly, the sensors are typically mounted in a robust and secure manner, which is often challenging to remove when the sensor units need to be replaced, repaired or collected for re-use.

In some cases, it is advantageous to place sensors in high places for data collection, such as on lights or telegraph poles. However, the act of mounting the sensors in a high place is difficult and dangerous, usually requiring a skilled tradesperson to climb or be lifted up to the high place in order to place the sensors. Moreover, for every time that the sensors need to be accessed, cleaned, replaced or maintained, the skilled trade person has to ascend each time. This complexity is further exacerbated by the need to involve complex bureaucratic procedure and adherence to strict safety procedures in populated or urban areas. For example, traffic may need to be diverted in order to access the high place requiring permits and causing traffic delays. Due to these issues, it is common for the sensors to be placed in other less advantageous locations that are more conveniently accessible.

The preferred embodiments of the present invention seek to address one or more of these disadvantages, and/or to at least provide the public with a useful alternative.

### SUMMARY OF INVENTION

In a first aspect, there is provided a housing for a sensor array comprising: a mounting plate for mounting the housing to a surface; a cover attachable to the mounting plate, where the mounting plate and the cover are shaped to form an internal cavity within the housing; the sensor array being housed within the internal cavity; and at least one air pathway in connection with the sensor array to enable air to pass from outside the housing to the sensor array.

In an embodiment, the air pathway is formed to enable the ingress and egress of air into the housing proximate to the sensor array.

In an embodiment, the air pathway is formed to prevent ingress of one or more contaminants to the sensor array.

In an embodiment, the one or more contaminants include water.

In an embodiment, the housing is arranged so that the internal cavity is divided into a first portion and a second portion.

In an embodiment, the first portion includes a control module.

In an embodiment, the control module includes one or more of any of the following; a programmable device; a microcontroller; a network connection device; a power source; an internal sensor; a serial port; a universal serial bus receptacle.

In an embodiment, the control module is attached to a universal attachment plate contained within the first portion.

In an embodiment, the first portion is waterproof.

In an embodiment, the second portion includes the sensor array.

In an embodiment, wherein the sensor array includes one or more sensors.

In an embodiment, the one or more sensors in the sensor array are directed to sensing the levels of one of the follow parameters; temperature; humidity; air pressure; distance of stationary or passing objects from radar, ultrasonic, passive infrared readings; radiation; radio-frequency identification data; sound level; acoustic pressure; luminosity; Carbon Monoxide; Carbon Dioxide; Molecular Oxygen; Ozone; Nitric Oxide; Nitric Dioxide; Sulfur Dioxide; Ammonia; Methane and other combustible gases; Molecular Hydrogen; Hydrogen Sulfide; Hydrogen Chloride; Hydrogen Cyanide; Phosphine; Ethylene Oxide; Chlorine; Isobutane; Ethanol; Toluene; volatile organic compounds; hydrocarbons; particle matter.

In an embodiment, the sensor array communicates at least one data set to the control module.

In an embodiment, the at least one data set is at least one analogue data set.

In an embodiment, the control module is programed to perform at least one data conversion process on the at least one analogue data set received from the sensor array.

In an embodiment, the at least one data conversion process includes converting the at least one analogue data set to at least one digital data set.

In an embodiment, wherein the air pathway is included in the second portion.

In an embodiment, the second portion further includes a labyrinth portion that defines the shape of the air pathway.

In an embodiment, the labyrinth portion includes an inner casing and an outer casing.

In an embodiment, wherein the inner casing is received within the outer casing such that one or more spaces between the inner casing and the outer casing define a shape of the air pathway.

In an embodiment, the air pathway includes at least one section that is arranged to extend orthogonally relative to the direction that the force of gravity acts.

In an embodiment, wherein the air pathway includes one or more vents.

In an embodiment, the labyrinth portion further includes at least one drainage pathway arranged to extend downwards from a first of the at least one vents to a second of the at least one vents.

In an embodiment, the one or more vents include a vent cover.

In an embodiment, the vent cover includes a portion of metal mesh.

In an embodiment, the vent cover is insect resistant.

In an embodiment, the vent cover is water resistant.

In an embodiment, the surface includes an aperture that is complementarily shaped and sized to engage with the housing.

In an embodiment, the aperture includes a boundary portion that is arranged to be engaged between the cover and a first attachment portion.

In an embodiment, the cover includes a lip arranged to fit tightly against the boundary portion such that the place of joining between the cover and the boundary portion has no edge.

In an embodiment, the housing further includes a mounting body arranged to connect the housing to a pole surface and retain a solar panel arrangement.

In an embodiment, the mounting plate includes an access hatch to enable accesses to the second portion.

In an embodiment, the cover includes a status indicator in connection with the control module.

In an embodiment, the status indicator is a light emitting diode device.

In an embodiment, there is provided a data collection and communication system comprising, a plurality of housings, each including the control module, wherein each of the plurality of housings is in communication with one another via a data network accordance with the first aspect.

In an embodiment, the data network further comprises at least one terminal that is programed to compile, and analyse the at least one digital data set received from the control module provided to each of the plurality of housings.

In a second aspect, there is provided a housing for a sensor array comprising: a head portion including the sensor array; a mounting plate including an engagement portion, the mounting plate being mounted to a surface, where the surface includes access to a supply of power and a network connection and the surface is arranged enable the supply of power and the network connection to the mounting plate and the engagement portion; wherein the engagement portion is removably attachable to the head portion and is arranged to supply of power and an exchange of data through the network connection between the sensor array and the surface.

In an embodiment, the head portion includes a base that is shaped to engage with the engagement portion.

In an embodiment, the head portion includes a cover portion connected to the base, wherein the cover portion and the head portion are shaped to form an internal cavity within the head portion.

In an embodiment, the internal cavity includes a control module.

In an embodiment, the control module includes one or more of any of the following; a programmable device; a microcontroller; a network connection device; a power source; an internal sensor; a serial port; a universal serial bus receptacle.

In an embodiment, the sensor array is attached to a sensor array plate mounted on the cover portion.

In an embodiment, the head portion is waterproof.

In an embodiment, the base includes a recess portion complementarily shaped to cooperatively engage with the engagement portion.

In an embodiment, the head portion includes a connector located between the recess portion and the engagement portion, which is removably attachable to at least one of the base or the engagement portion.

In an embodiment, the connector includes a first set of pins and a second set of pins in connection with one another that enable the supply of at least one of power and data between the head portion and the engagement portion.

In an embodiment, the head portion further includes at least one attachment mechanism provided to the base.

In an embodiment, the at least one attachment mechanism is arranged to slidably engage with at least one receiving recess portion provided to the mounting plate.

In an embodiment, the at least one attachment mechanism is arranged to slidably engage with the at least one receiving recess portion in a snap fit arrangement.

In an embodiment, the at least one attachment mechanism includes a lever for disengaging the at least one attachment mechanism from the at least one receiving recess portion.

In an embodiment, the sensor array includes one or more sensors.

In an embodiment, the one or more sensors in the sensor array are directed to sensing the levels of one of the follow parameters; temperature; humidity; air pressure; distance of stationary or passing objects from radar, ultrasonic, passive infrared readings; Ultra Violet (UV) light; solar irradiance; radiation; the effect of the quantum state of another system on itself; luminosity; photons; acoustic resonance; sound level; acoustic pressure; wind strength and direction; rainfall; radio-frequency identification data; Carbon Monoxide; Carbon Dioxide; Molecular Oxygen; Ozone; Nitric Oxide; Nitric Dioxide; Sulfur Dioxide; Ammonia; Methane and other combustible gases; Molecular Hydrogen; Hydrogen Sulfide; Hydrogen Chloride; Hydrogen Cyanide; Phosphine; Ethylene Oxide; Chlorine; Isobutane; Ethanol; Toluene; volatile organic compounds; hydrocarbons; particle matter.

In an embodiment, the sensor array communicates at least one data set to the control module.

In an embodiment, the at least one data set is at least one analogue data set.

In an embodiment, the control module is programed to perform at least one data conversion process on the at least one analogue data set received from the sensor array.

In an embodiment, the at least one data conversion process is converting the at least one analogue data set to at least one digital data set.

In an embodiment, there is provided a data collection and communication system comprising, a plurality of housings, each including the control module, wherein each of the plurality of housings are in communication with one another via the network connection in accordance with the second aspect.

In an embodiment, the data network further comprises at least one terminal that is programed to compile, and analyse the at least one digital data set received from the control module provided to each of the plurality of housings.

In a third aspect, there is provided a deployment system for deploying the housing in accordance with the second aspect on a pole surface that includes a mounting plate, the deployment system including a deployment device comprising: two arms formed to removably engage around the circumference of the pole surface; at least one powertrain for translating the deployment device up, down, and around the pole surface; a deployment mechanism for actuating the housing into an engaged position with the mounting plate

In an embodiment, the two arms are hingingly engaged at a first end, which is proximate to the deployment mechanism.

In an embodiment, the two arms include a locking mechanism that fixes the two arms in an engaged position with the pole surface.

In an embodiment, the two arms are formed to include a chassis that supports the at least one powertrain.

In an embodiment, the at least one powertrain includes at least one motor.

In an embodiment, the at least one powertrain includes at least one motor controller and at least one omni-directional wheel in connection with the at least one motor.

In an embodiment, the deployment mechanism includes a track, which is formed to slidingly engage the clip mechanism provided to the base with the mounting plate.

In an embodiment, the track includes two members shaped to engage with the housing and disengage the housing from the mounting plate.

In an embodiment, the deployment mechanism includes a camera.

In an embodiment, the deployment device further includes a cleaning attachment for cleaning the sensors provided to the head portion when engaged with the mounting plate.

In an embodiment, the cleaning attachment is further arranged to clean lighting system lenses provided to the surface.

In an embodiment, the deployment device includes a cable in connection with a control system and an interface.

In an embodiment, the cable further provides power to the deployment device.

Furthermore, terms such as “front”, “rear”, “top”, “bottom”, “side”, and the like are only used to describe elements as they relate to one another, but are in no way meant to recite specific orientations of the device, to indicate or imply necessary or required orientations of the device, or to specify how the invention described herein will be used, mounted, displayed, or positioned in use.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein, which have known equivalents in the art to which this invention relates; such known equivalents are deemed to be incorporated herein as if individually set forth.

As used herein the term ‘(s)’ following a noun means the plural and/or singular form of that noun. Further, as used herein the term ‘and/or’ means ‘and’ or ‘or’, or where the context allows both. The invention also envisages constructions of which the following gives examples only.

Throughout this specification and the claims that follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### BRIEF DESCRIPTION OF FIGURES

The present invention is described by way of non-limiting examples within the following description and figures.

FIG. 1 is an exploded perspective view of a housing in accordance with an embodiment of the present invention.

FIG. 2 is a side section view of a housing in accordance with an embodiment of the present invention.

FIG. 3 is a data collection and communication system diagram in accordance with an embodiment of the present invention.

FIG. 4 is a front view of a housing in accordance with an embodiment of the present invention.

FIG. 5 is a back view of a housing in accordance with an embodiment of the present invention.

FIG. 6 is a side view of a housing in accordance with an embodiment of the present invention.

FIG. 7 is a bottom view of a housing in accordance with an embodiment of the present invention.

FIG. 8 is a top-down section view of a housing in accordance with an embodiment of the present invention.

FIG. 9 is a side section view of a housing in accordance with an embodiment of the present invention.

FIG. 10 is a front view of a housing in accordance with an embodiment of the present invention.

FIG. 11 is a bottom-up section view of a housing in accordance with an embodiment of the present invention.

FIG. 12 is a back view of a housing in accordance with an embodiment of the present invention.

FIG. 13 is a side section view of a housing in accordance with an embodiment of the present invention.

FIG. 14 is a side section view of a housing in accordance with an embodiment of the present invention.

FIG. 15 is a front view of a housing in accordance with an embodiment of the present invention.

FIG. 16 is a rear perspective exploded view of a housing in accordance with an embodiment of the present invention.

FIG. 17 is a rear perspective exploded view of a housing in accordance with an embodiment of the present invention.

FIG. 18 is a top perspective view of a housing in accordance with an embodiment of the present invention.

FIG. 19 is an exploded perspective view of a housing in accordance with an embodiment of the present invention.

FIG. 20 is a top perspective view of a housing in accordance with an embodiment of the present invention.

FIG. 21 is a side view of a housing in accordance with an embodiment of the present invention.

FIG. 22 is a side section view of a housing in accordance with an embodiment of the present invention.

FIG. 23 is a top view of a housing in accordance with an embodiment of the present invention.

FIG. 24 is a side view of a housing in accordance with an embodiment of the present invention.

FIG. 25 is a further side view of a housing in accordance with an embodiment of the present invention.

FIG. 26 is a perspective view of a housing in accordance with an embodiment of the present invention.

FIG. 27 is a side view of a housing in accordance with an embodiment of the present invention.

FIG. 28 is a perspective view of a housing in accordance with an embodiment of the present invention.

FIG. 29 is an exploded perspective view of a housing in accordance with an embodiment of the present invention.

FIG. 30 is a side perspective view of a deployment system in accordance with an embodiment of the present invention.

FIG. 31 is a further perspective view of a deployment system in accordance with an embodiment of the present invention.

### DETAILED DESCRIPTION

In broad terms, the present invention provides a housing for a sensor array, a data collection and communication system, and a deployment system. Within the broader inventive concept, various embodiments of the housing and systems are described and defined in further detail below. Within the description and the figures, reference to like numbers denotes reference to like features.

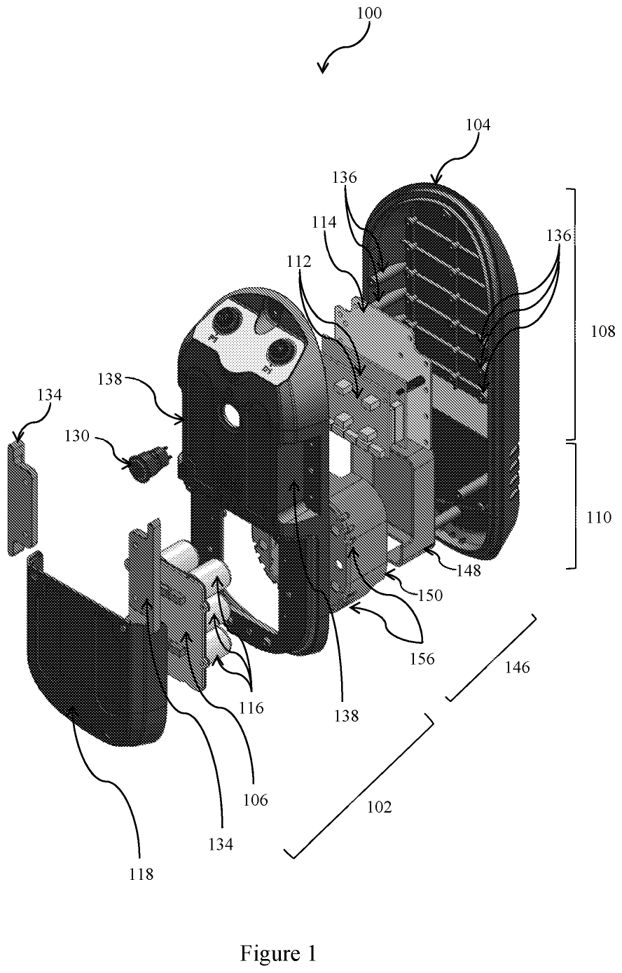

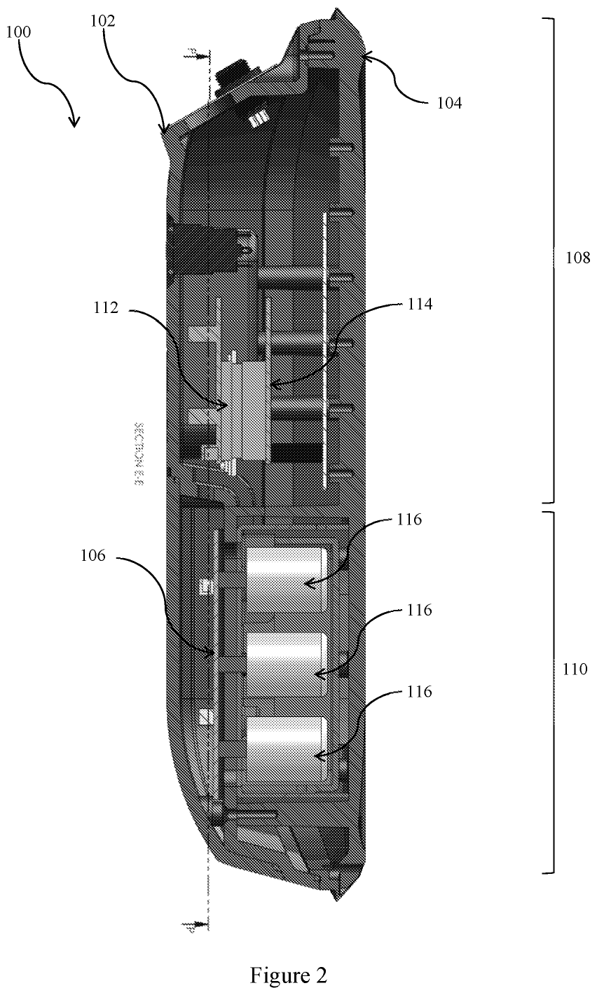

Referring to FIGS. 1 and 2, an embodiment is provided comprising a housing 100 for a sensor array 106. The housing 100 includes a mounting plate 102 for mounting the housing 100 to a surface, a cover 104 attachable to the mounting plate 102, where the mounting plate 102 and the cover 104 are shaped to form an internal cavity within the housing 100. The sensor array 106 is arranged to be contained within the internal cavity, and at least one air pathway in connection with the sensor array 106, which enables air to pass from outside the housing 100 and into the sensor array 106.

Within the specification, a surface is understood to be a physical structure on to which the housing may be mounted. This may include walls, poles, ceilings, vehicles, or other objects. The surface may be mounted to or located on the exterior of a building or structure, or be mounted to or located within the interior of a building or structure. The surface may be substantially planar or flat, such as a wall, or a ceiling. Alternatively, the surface may also be curved, such as a length of a cylindrical pole, such as a streetlight or telegraph pole. Moreover, the surface may also include the substantially planar top of cylindrical pole, such as a streetlight or telegraph pole. Further, the surface may include access to power and/or a communication network. Access may be in the form of a power and/or communication conduit passing through or being mounted to the surface. Alternatively, the surface may include an integrated power and/or communication conduit as part of the structure, or be proximate to a wireless communication means, such as a Wi-Fi network.

In an embodiment, the air pathway is formed to enable the ingress and egress of air into the housing 100 proximate to the sensor array 106. In a further embodiment, the air pathway is formed to prevent ingress of one or more contaminants to the sensor array 106. The one or more contaminants may include any material that would negatively affect the operability of the sensor array 106 (or other ancillary electronics) by its presence, or any material that may generate error or bias in the sensor readings. This may include liquids, solids, solids being born by gases or liquids, or any mixture of such material. For example, contaminants may include water, human or animal waste, soil, sand, dust, pollen or other forms of plant matter. The terms “ingress” and “egress” are used within the specification in the bounds of their normal meaning, being the act of entering and the act of leaving, respectively.

In an embodiment, the housing 100 includes a first portion 108 and a second portion 110. The first portion 108 and the second portion 110 may be arranged such that the internal cavity is divided into sub-cavities, namely the first portion 108 and the second portion 110. In other words, the housing 100 may be arranged to include the first portion 108 and the second portion 110 as separate compartments of the housing 100. In an embodiment, the first portion 108 may include a control module 112, where the control module 112 includes one or more of any of the following components, which are arranged to communicate or be in connection with one another:
a. a programmable device, which is an electronic component that is programed to carry out instructions. The programmable device may be programed through a code language that is stored on the device, such as but not limited to C, C++ or python. For example, the device may include memory, which contains the coded instructions, and a processor capable of reading and carrying out the instructions. Alternatively, the programmable device may be programmed inherently within structure of the device itself. For example, the device may include one or more logic gates set up to function in accordance with the instructions, such as logic gates formed by diodes or transistors vacuum tubes, electromagnetic relays that act as electronic switches.
b. a microcontroller, which is a control device which incorporates a microprocessor. For example, a microcontroller may be small computer comprised of a single integrated circuit. The microcontroller may include one or more processor cores, memory, programmable input and output peripherals.
c. a network connection device, or data network device that enables multiple computer devices (terminals or nodes) that share data to one another over a network of data links. The network infrastructure can include devices such as a telephone switch, base station, bridge, router, or any other such specialised network component, which facilitates the connection between a terminal and an information source. The network itself may take a variety of forms. For example, it may be a computer network, telecommunications network, data communications network, Local Area Network (LAN), Wide Area Network (WAN), wireless network, Ethernet, the Internet and developments thereof, transient or temporary networks, combinations of the above or any other type of network providing for communication between computerised, electronic or digital devices. More than one distinct network can be provided, for example a private and/or a public network. A network as referenced in this specification should be taken to include any type of terminal or other similar type of electronic device, or part thereof, which is rendered such that it is capable of communicating with at least one other terminal.
d. a power source that supplies electrical power for the operation of electronics housed within the housing. The power source may include mains power, battery power, solar power or any other source of power to enable the workings of the invention.
e. an internal sensor to detect a fault or to detect unauthorised access to the housing. An internal sensor to detect a fault may include a humidity sensor provided proximate to the sensor array to detect the ingress of water, which may also include an indicator signal or light to indicate the presence of a fault. An internal sensor to detect unauthorised access may include a motion detector, tilt or gyroscopic detector, air-pressure sensor, or light sensor. Further, the sensor may be provided to the programmable device, such as a switch watchdog.
f. a serial port, which is a serial communication interface through which information transfers in or out one bit at a time. This may include serial ports compliant with RS-232 standard, in addition to other serial data interfaces, such as Ethernet and FireWire, or thunderbolt.
g. a universal serial bus (USB) receptacle, which is a further serial communication interface through which information transfers in or out one bit at a time, which is commonly used for connecting hardware peripheral systems, such as storage devices, human interface devices, or used for the communication between computing devices.

In an embodiment, the control module 112 may be attached to a universal attachment plate 114 contained within the first portion 108. The universal attachment plate 114 includes a plate portion having a plurality of apertures passing through the plate portion to enable the attachment of the control module 112 to any respective additional electronic components. The universal attachment plate 114 is shaped to fit within the first portion 108 and to provide sufficient room to retain the control module 112 and the respective additional electronic components. The universal attachment plate 114 is mounted to at least one of the cover 104 or mounting plate 102. In an embodiment, the universal attachment plate 114 may be mounted to both the cover 104 and mounting plate 102, such that the universal attachment plate 114 and the electronic components are suspended between the internal surfaces of the internal cavity of the first portion 108.

In an embodiment, the first portion 108 may be waterproof In another embodiment, the housing 100 may also be hermetically sealed, that is, the first portion 108 is airtight. As such, the housing 100 may include chemical or mechanical sealants that enable the first portion 108 to prevent the ingress of water and/or to prevent the ingress of air. For example, the housing 100 may include various chemical or mechanical sealants proximate to the perimeter of the first portion 108, such as but not limited to epoxy resin sealant, natural or synthetic O-ring, Polytetrafluoroethylene tape or resin, or other similar methods of creating a waterproof seal and/or air tight seal. Any wiring passing in or out of the first portion 108 may be appropriately insulated and sealed, so that the first portion 108 remains waterproof and/or airtight. The housing may be made waterproof or airtight to a specific known standard, such as but not limited to IP65 or IP66 enclosure waterproof ratings.

In an embodiment, the second portion 110 includes the sensor array 106, where the sensor array 106 includes one or more sensors 116. The one or more sensors 116 may be housed within the housing 100 or, alternatively, mounted to the housing 100, wherein the one or more sensors 116 are capable of sensing the levels or concentrations of a variety of parameters or environmental conditions. For example, the sensors may include, but are not limited to, a temperature sensor, hygrometer, air pressure sensor, radar, passive infrared sensor, gigameter, radio-frequency sensor, sound level meter, light or photometric sensor, quantum sensor, pyranometer, photon detector, actinometer, and/or a gas sensor. As such, the sensor array 116 may include one or more of each of the above sensors or a combination of such sensors.

The one or more sensors 116 may be directed to sensing the levels or concentrations of the variety of parameters or environmental conditions. The parameters may include one or more of temperature, humidity, air pressure, distance of stationary or passing objects from radar, ultrasonic, passive infrared readings, radiation, Radio-frequency identification data, sound level, acoustic pressure, the effect of the quantum state of another system on itself, luminosity, Carbon Monoxide, Carbon Dioxide, Molecular Oxygen, Ozone, Nitric Oxide, Nitric Dioxide, Sulfur Dioxide, Ammonia, Methane and other combustible gases, Molecular Hydrogen, Hydrogen Sulfide, Hydrogen Chloride, Hydrogen Cyanide, Phosphine, Ethylene Oxide, Chlorine, Isobutane, Ethanol, Toluene, Volatile Organic Compounds, Hydrocarbons, or particle matter, such as dust or lead particulates. As such, each of the one or more sensors 116 may be directed to sensing the levels or concentrations of a single of the above parameters or one or more of the above parameters.

In an embodiment, the mounting plate 102 may include an access hatch 118 to enable access to the second portion 110. For example, the access hatch 118 may be provided proximate to the sensor array 116 as a detachable portion of the mounting plate 102, such that the sensor array 116 may be accessed, repaired or replaced without dismantling the entire housing 100. The access hatch 118 may be removably attachable to the mounting plate 102 by means of one or more fasteners such as screws, bolts or other removable fasteners. The access hatch 118 may also include one or more hinge elements (not shown) that enable the access hatch 118 to be pivotally opened to provide access to the second portion 110.

In an embodiment, the sensor array 106 communicates at least one data set from the one or more sensors 116 to the control module 112. As such, the sensor array 106 may be in wired or wireless communication with the control module 112. Moreover, the at least one data set may include at least one digital data set collected from the one or more sensors 116 in relation to the levels of any of the above described parameters.

Alternatively, the at least one data set may include at least one analogue data set collected from the one or more sensors 116 in relation to the levels of any of the above described parameters. As such, the sensor array 106 may be in wired communication with the control module 112. Where the at least one data set collected from the one or more sensors 116 is an analogue data set, the control module 112 may be programed to perform at least one data conversion process on the at least one analogue data set received from the sensor array 106, wherein the at least one data conversion process may include converting the at least one analogue data set to at least one digital data set. For example, the control module 112 may be programed to convert an analogue electrical current reading from the sensor array 106 to digital parameter measure.

Moreover, the conversion process may be based on a known mathematical relationship. For example where the electrical current readings generated by each of the one or more sensors 116 are linearly related to the fractional volume of one of the parameters. Moreover, some additional processing may also be performed by the control module 112 including, smoothing data readings to account for reading fluctuations, storing calibration baseline data, and sensitivity data, calculating a moving average calculation for noise reduction, and other similar programmable data processing or communication processes.

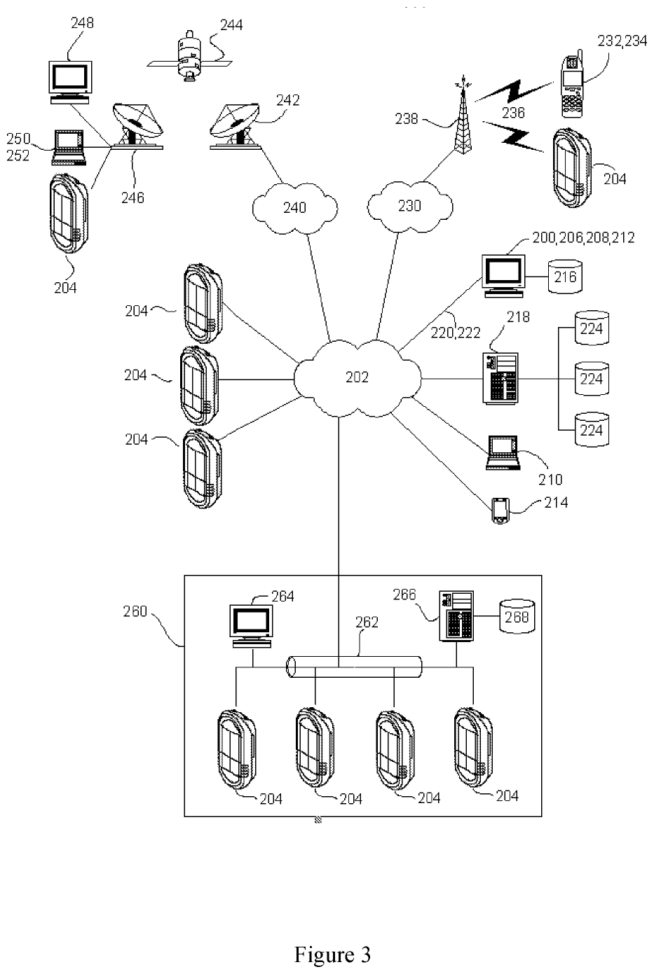

In an embodiment, there is provided a data collection and communication system 200, as shown in FIG. 3, where the data collection system includes a data network 202 in communication with a plurality of housings 204 in accordance with the housing 100. That is, the each of the plurality of housings 204 and other network nodes are connected in a networked communication system. Terminal 200 may also connect to data network 202, for example, via the Internet or a Wide Area Network (WAN). Input data and output data may be communicated to other devices via network 202. Other terminals connected to the data network 202 may include but are not limited to, a thin client device 206, further processing system 208, notebook computer 210, mainframe computer 212, mobile device 214, database 216, server 218, etc. A large variety of other types of terminals or configurations may also be utilised. The transfer of information and/or data over data network 202 may be achieved using wired communications means 220 or wireless communications means 222. Server 218 may also facilitate the transfer of data between the data network 202 and one or more databases 224. For example, the at least one digital data set may be transferred from the control module 112 of one of the plurality of housings 204 to a terminal 200.

Terminal 200 may be in further in connection with database 216, or server 218 and one or more databases 224 that enable the storage of data and further data processing and analysis. For example, the data network facilitates the transference the at least one digital data set received from a control module provided to each of the plurality of housings 204 to any other terminal on the data network 202. For example, the at least one digital data set received from the control module 112 provided to each of the plurality of housings 204 may be communicated to the terminal 200 in connection with database 216, or server 218 in connection with the one or more databases 224, wherein either of these network nodes may be capable of receiving, compiling, and/or analysing the at least one digital data set.

Other networks may also communicate with data network 202. For example, telecommunications network 230 may facilitate the transfer of data between data network 202 and mobile or cellular telephone 232 or a mobile device 234, such as a smart phone, tablet or PDA device, by utilising wireless communication means 236 and receiving/transmitting station 238. Alternatively, satellite communications network 240 may communicate with satellite signal receiver 242, which receives data signals from satellite 244, which in turn is in remote communication with satellite signal transmitter 246. Terminals, such as a further processing system 248, notebook computer 250, mobile device 252, or indeed another housing 204 may communicate with data network 202. A local network 260, which for example may be a private network, LAN, etc., may also be connected to data network 202. For example, data network 202 may be connected with Ethernet 262, which connects the plurality of housings 204, terminal 264, and server 266, which controls the transfer of data to and/or from database 268. Various other types of networks may also be utilised as would be understood by a person skilled in the art.

The network shown in FIG. 3 is adapted to communicate with other terminals, for example the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA, 3G or 4G etc., networks, and may be wholly or partially wired, including for example optical fibre, or wireless networks, depending on a particular implementation.

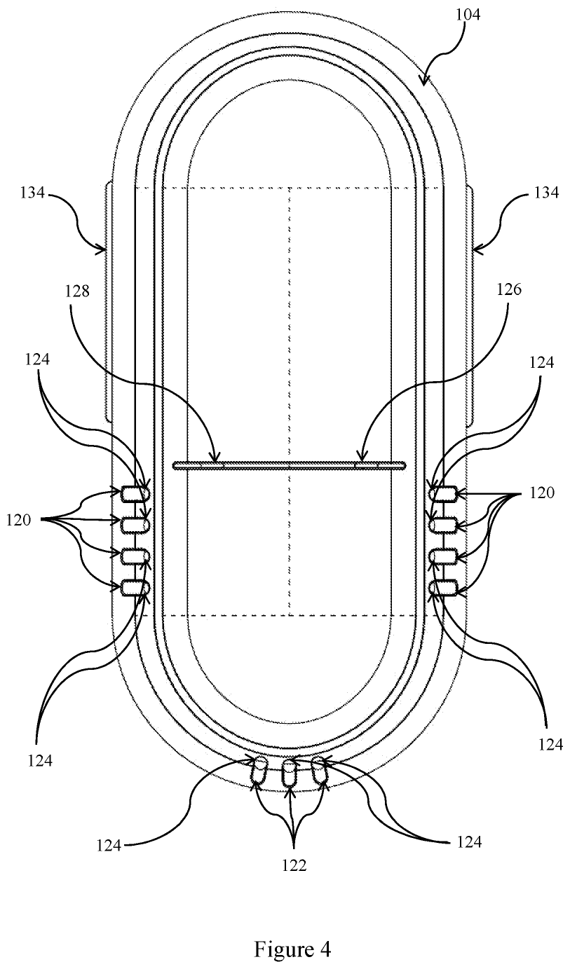

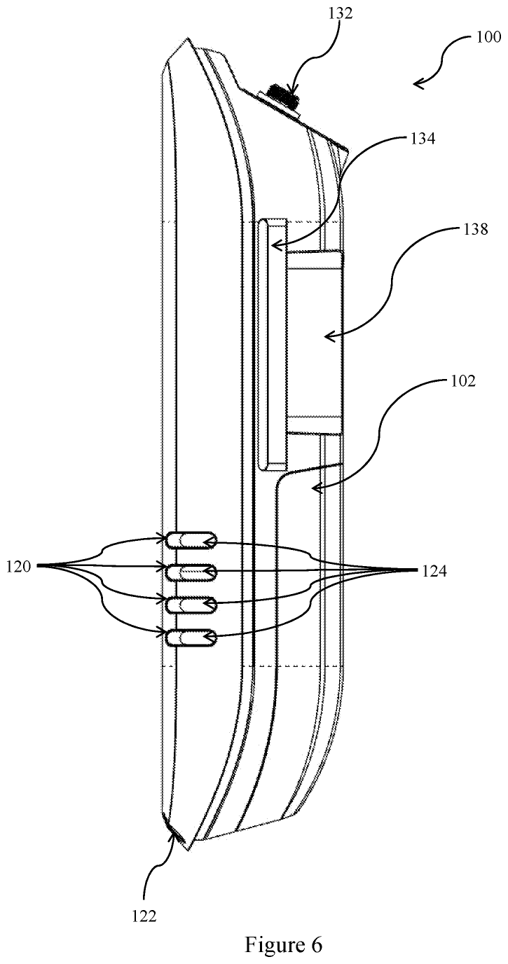

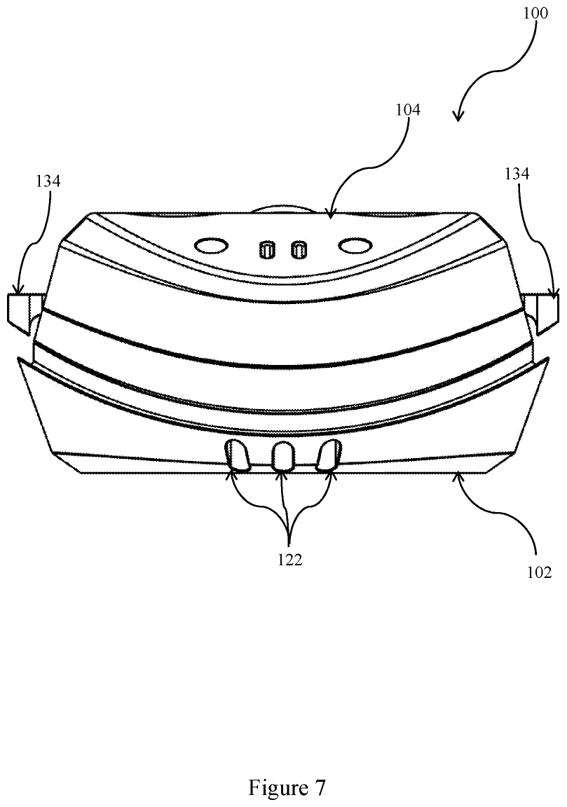

Referring to FIGS. 4 to 14, an embodiment of the housing 100 is provided, wherein the mounting plate 102 and the cover 104 are shaped to form an internal cavity within the housing 100. The sensor array 106 may be contained within the internal cavity, for example, within the second portion 110. The air pathway is arranged to extend from outside the housing 100, into the housing, and to the sensor array 106. Air pathway is a term used to describe the path taken by the air, where the housing 100 is arranged to form the air pathway along which air will flow to enter into the housing 100 through the cover to get to the sensor array 106 housed in the section portion 110. The air pathway is described in further detail later in the specification.

In an embodiment, the air pathway includes one or more vents provided to the air pathway. That is, the air passing along the air pathway passes through one or more vents to enter the housing 100. The one or more vents may include one or more primary vents 120 that are provided to the sides of the second portion 110 to enable air to pass from outside the housing 100 to the sensor array 106 housed in the second portion 110. Additionally, the one or more vents may include one or more secondary vents 122 provided in the bottom of the second portion 110 to enable air to pass from outside the housing 100 to the sensor array 106 housed in the second portion 110. Moreover, the one or more secondary vents 122 may also enable drainage of water and other contaminants from the housing 100.

In an embodiment, each of the one or more primary vents 120 and/or each of the one or more secondary vents 122 may include a vent cover 124. The vent cover 124 is arranged to at least partially cover the openings in the cover 104 provided by the one or more vents 120 and/or 122. The vent cover 124 may include a portion of mesh. The mesh may be made from a portion of plastic or metal mesh, wherein the plastic mesh may be extruded, oriented, expanded, woven, or be tubularly formed and may be made from polypropylene, polyethylene, nylon, polyvinyl chloride or polytetrafluoroethylene. Metal meshes may be woven, knitted, welded, expanded, photo-chemically etched or electroformed from steel or other non-corrosive metals or alloys. Alternatively, the mesh may also be made out of fibreglass material. The mesh may be arranged such that the gaps between the strands of the mesh are sufficiently small to be insect resistant. Further, the mesh may be arranged to be sufficiently strong and the gaps between the strands of the mesh are sufficiently small to disperse a stream of fluid under pressure such that the fluid does not enter the air pathway. As such, such the vent 124 cover may be arranged to be water resistant.

Referring specifically to FIG. 4, an embodiment is provided where the cover 104 includes a status indicator 126 in connection with the control module 112. The status indicator 126 may include a light emitting diode (LED) device that indicates the status of the control module 112 housed in the first portion 108. For example, the LED device may be programmable to display different colours or flashing patterns that are associated with the current operational status of the control module 112. For example, a constantly lit LED device may indicate that the control module 112 is operating without issue, whilst a flashing LED device may indicate a fault. The LED device may be programmed to display lighting signals to indicate a variety of possible operational statuses, as would be understood by the person skilled in the art.

In a further embodiment, the cover 104 may include user interface 128 that may include a microphone and/or speaker. The cover 104 may also include one or more buttons (not shown) which may be pressed by a user in order to summon assistance or open a communication channel with a remote operator associated with the data collection and communication system. As such, the control module 112 may further include an audio processor and amplifier in connection with the microphone and/or speaker. As such, any analogue data received by the microphone is converted to a digital audio signal and communicated through the data network 202 (in a similar manner to the sensor array 106 data) to enable the transmission of audio between one of the plurality of housings 204 and another terminal 210 as shown in FIG. 3. That is, the user interface 128 enables the user and the remote operator to communicate with one another. Alternatively, the user interface 128 and control module 112 may be configured to enable the transmission of audio data between one of the plurality of housings 204 and another of the plurality of housings 204.

As would be understood by the person skilled in the art, the arrangement and position of the status indicator 126 and the user interface 128 may be varied within the scope of the invention. The locations of these two features are provided to assist the skilled addressee in understanding the invention, and as such, the locations should not to be taken as limiting.

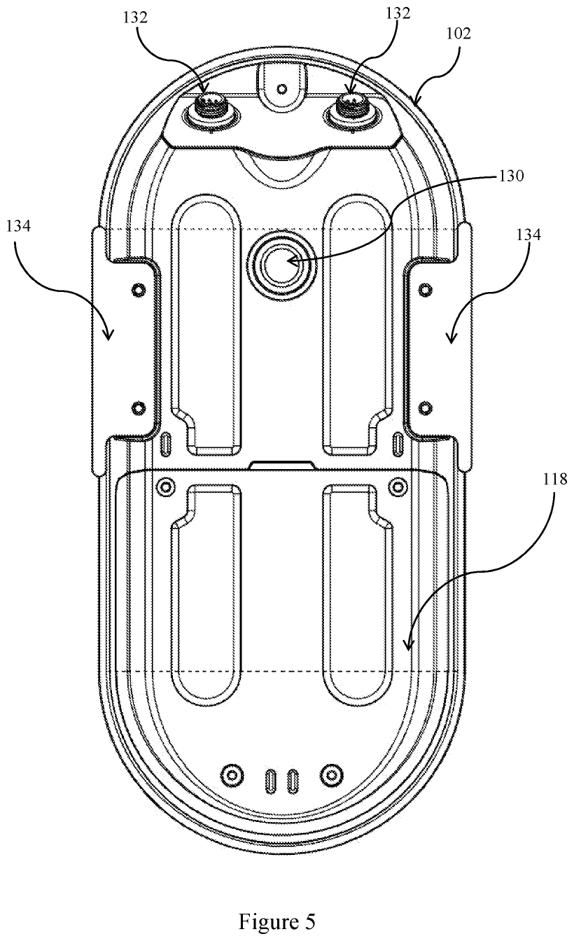

Referring to FIG. 5 to FIG. 9, an embodiment is provided including a mounting plate 102. The mounting plate 102 may include a power switch 130 provided to the first portion 108. The power switch 130 may be used by a user to selectively turn on and off the supply of power to the housing 100 provided by the surface or another form of power provided by a local power source such as solar cell or battery power. The power switch 130 may include one or more LED devices that indicate whether the power has been “switched on” or “switched off”.

The mounting plate 102 may also include one or more electrical ports 132 provided to the first portion 108. The one or more electrical ports 132 may include an electrical power port or a network communication port. For example, through the electrical ports 132, the housing may receive power from or receive and transmit data to/from the surface.

The mounting plate 102 may also include a first attachment portion 134 which engages with the mounting plate 102 and a corresponding second attachment portion 136 (shown in FIG. 1) provided to the interior of the cover 104. Each of the second attachment portions 136 may be a small aperture that protrudes towards outwards from the interior edge of the cover 104. Each aperture may at least partially extend into the edge of the cover 104 so that a fastener may be received and retained within each of the second attachment portions 136, where the fastener holds the first attachment portion 134 and the second attachment portion 136 together with the mounting plate held between. The mounting plate 102 may also be shaped to include a recess 138 extending through the internal cavity, which is capable of receiving the first attachment portion 134, such that the mounting plate 102 is joined to the cover 104 by means of the first attachment portion 134 and the second attachment portion 136. That is, the first attachment portion 134 connects to the second attachment portion 136 through the mounting plate 102, where each of the first attachment portion 134, recess 138 and the second attachment portion 136 each include apertures capable of receiving and retaining conventional fastening means such as screws, bolts or similar mechanical fastening devices.

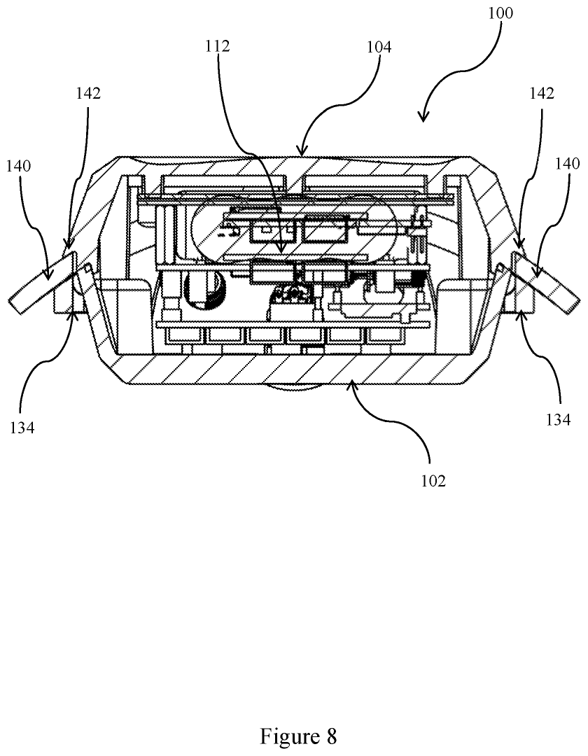

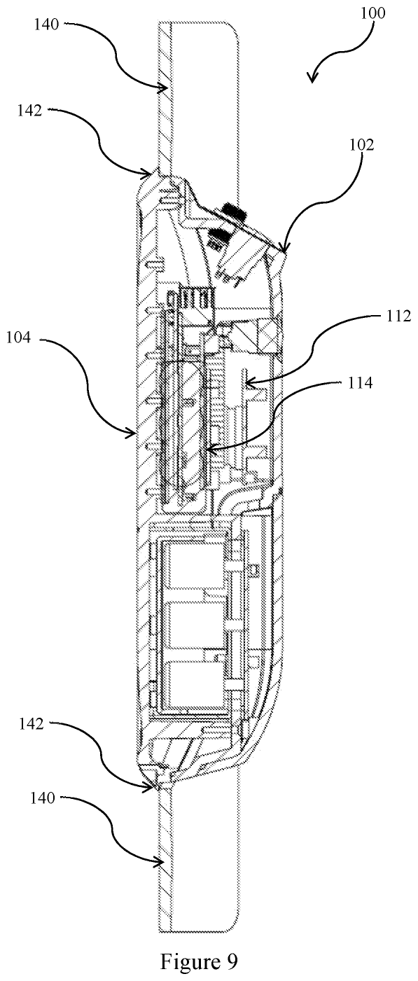

Moreover, referring to FIGS. 8 and 9, the first attachment portion 134 and the cover 104 are arranged to engage with the surface. In an embodiment, the surface includes an aperture that is complementarily shaped and sized to receive the housing 100. The aperture formed in the surface includes a boundary portion 140, which is arranged to be engaged between the cover 104 and the first attachment portion 134. The cover 104 may include a lip 142 that is slantingly arranged to fit tightly against the outer face of the boundary portion 140 such that the place of joining between the cover 104 and the boundary portion 140 has no edge. The first engagement portion 134 may also include a slanted edge to tightly engage with the inner face of the boundary portion 140 such that the surface is firmly retained between the first attachment portion 134 and the cover 104. Accordingly, this arrangement enables the housing 100 to be mounted to the surface. Alternatively, the housing 100 may be mounted to the surface by means of conventional fastening mechanisms such as screws or bolts passing though the housing 100 and mounting it to the surface. Alternatively, the housing may be mounted to the surface using snap fit arrangements, Velcro™, chemical adhesives or other similar permanent or temporary methods of attaching the housing 100 to the surface.

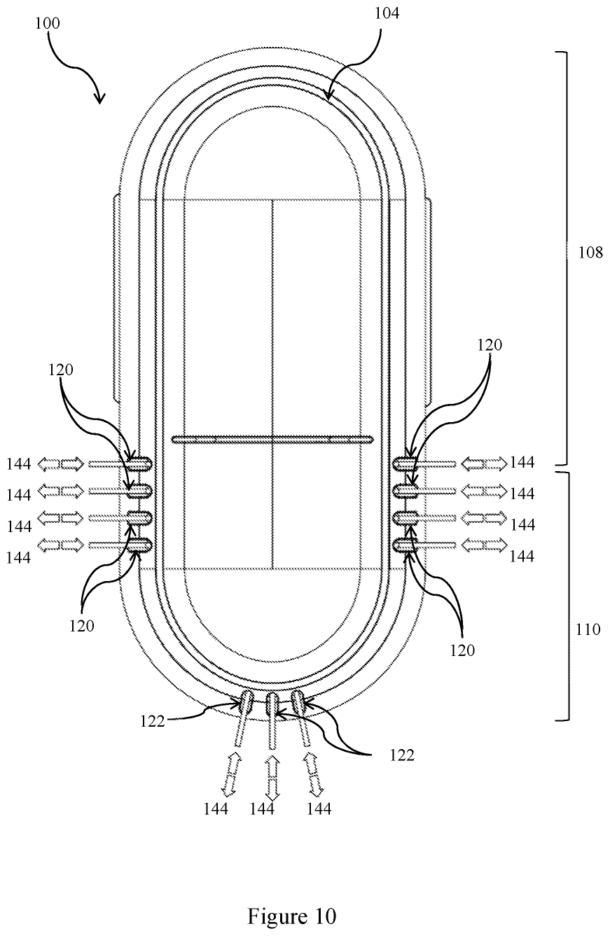

Referring to FIG. 10, an embodiment is provided where the air pathway is included in the second portion 110. An end of the air pathway is show by the arrows 144 as entering and exiting the area external to the housing 100 via the one or more vents 120 and/or 122. Referring briefly to FIG. 1, the second portion 110 may include a labyrinth portion 146, which defines the shape of the air pathway. The labyrinth portion 146 includes an inner casing 148 and an outer casing 150, wherein the inner casing 148 may be received within the outer casing 150, such that one or more gaps between the inner casing 148 and the outer casing 150 define a shape of the air pathway.

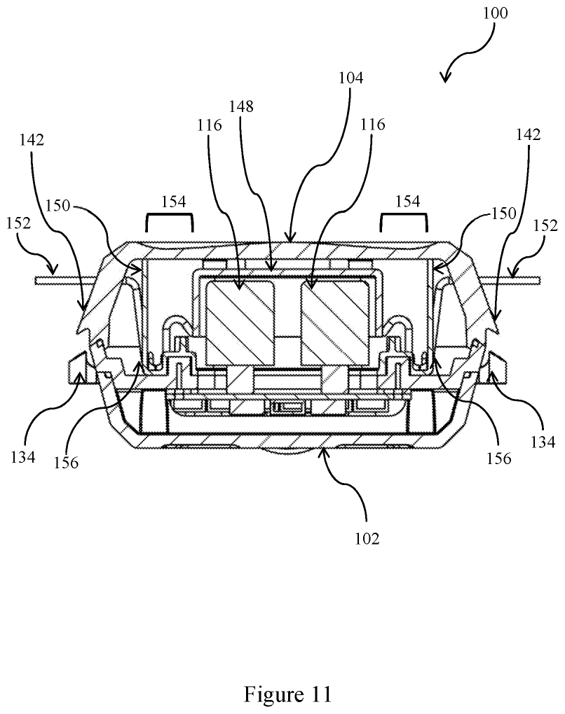

Referring to FIG. 11, a non-limiting example of an air pathway 152 is provided, wherein the inner casing 148 is received within the outer casing 150. The inner casing 148 and the outer casing 150 are convexly shaped so that when the inner casing 148 is received within the outer casing 150, there is provided a cavity in the space between them. The sensor array 106, which includes one or more sensors 116, may be located in the cavity formed between the inner casing 148 and the outer casing 150. The inner casing 148 is shaped and sized so that it is when received within the outer casing 150 there is a space 154 that extends between the convex face of the inner casing 148 and the concave face of the outer casing 150.

Moreover, the outer casing 150 may further include one or more air path apertures 156 (shown best in FIG. 1) near the boundary of the outer casing 150 that enables air to pass along the air pathway 152. Accordingly, an example of an air pathway 152 is provided, where air flows through the air pathway 152 from outside the housing, through the one or more primary vents 120 and/or the one or more secondary vents 122 into the housing 100. The air pathway 152 may be formed within the housing 100 so that the air flowing along the air pathway 152 takes a tortuous or indirect path. For example, the air may pass through vents 122 and through one or more air path apertures 156 into the cavity between the inner casing 140 and the outer casing 150. The air may then pass though the spaces 154 between the convex face of the inner casing 148 and the concave face of the outer casing 150, and into the inner casing 148 proximate to the sensor array 106.

The air pathway 152 as described is an example of the arrangement of the labyrinth portion 146 that is merely provided to assist the skilled addressee's understanding of the workings of an embodiment of the presentation invention. As such, the specific arrangement described is not to be considered as limiting would be understood by skilled addressee. As such, alternate arrangements of the labyrinth portion 146 are within the scope of the embodiments described. For example, the labyrinth portion 146 may include further casings, apertures and air pathways that enable air to pass from outside the housing 100 to the sensor array 106 and enable the egress of air to pass from the sensor array 106 to outside of the housing 100.

The labyrinth portion 146 may also include further features to prevent ingress of one or more contaminants to the sensor array 106. For example, the labyrinth portion 146 may also include a drainage path extending downwards from the one or more primary vents 120 to the one or more secondary vents 122 provided at the bottom of the housing 100 to enable any contaminants, such as water, that may have entered through the primary vents 120 to be drained away through the one or more secondary vents 122.

A further example of additional features included in the labyrinth portion 146 is provided where at least one section of the air pathway 152 being arranged to extend orthogonally relative to the direction that the force of gravity acts, so that any contaminants, such as water, that enter through the primary vents 120, will be affected by gravity and not pass through the one or more air path apertures 156 into the sensor array 106. In other words, any water will encounter the vertical portion and run down the housing 100 to the one or more secondary vents 122 and not enter the labyrinth portion 146. Yet another example may include the one or more air path apertures 156 being located above the one or more primary vents 120, so that any contaminants, such as water, that enter through the primary vents 120, will be unable to pass upwards against the force of gravity in order to enter through the one or more air path apertures 156 into the sensor array 106.

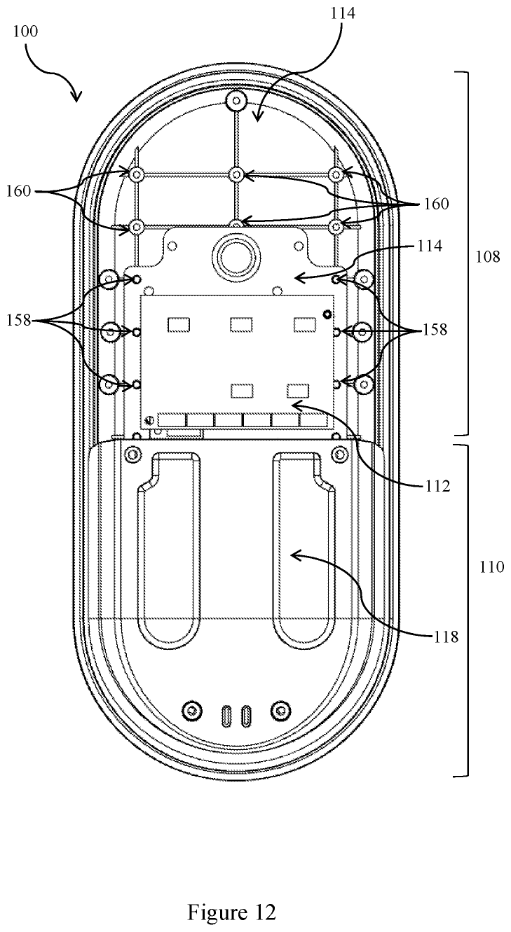

The housing 100 may be provided in a number of different arrangements. For example are provided in FIGS. 12 to 14. The examples are included for illustrating the workings of the embodiments of the present invention to the person skilled in the art, and as such, should not be considering limiting.

With reference to FIG. 12, an embodiment of a housing 100 is provided, wherein the back mounting portion 102 is shown partially cut away. The first housing 100 includes the first portion 108 and the second portion 110. The second portion 110 includes the sensor array (not shown), which is accessible by access hatch 118. The first portion 108 includes the control module 112, which is attached to the universal attachment plate 114. The universal attachment plate 114 is attached to the cover 104 of the housing 100 by means of fasteners 158, such as but are not limited to screws, which are received within fastener receivers 160 provided to the interior face of the cover 104. The fastener receivers 160 provided to the cover 104 may be provided in a uniform grid pattern of orthogonally arranged rows and columns to enable the universal attachment plate 114 to be attached to the cover 104 in a variety of positions or arrangements. Each of the fastener receivers 160 may be a small aperture that protrudes towards outwards from the interior face of the cover 104, where each aperture at least partially extends into the cover 104 so that a fastener may be received and retained within each of the fastener receivers 160.

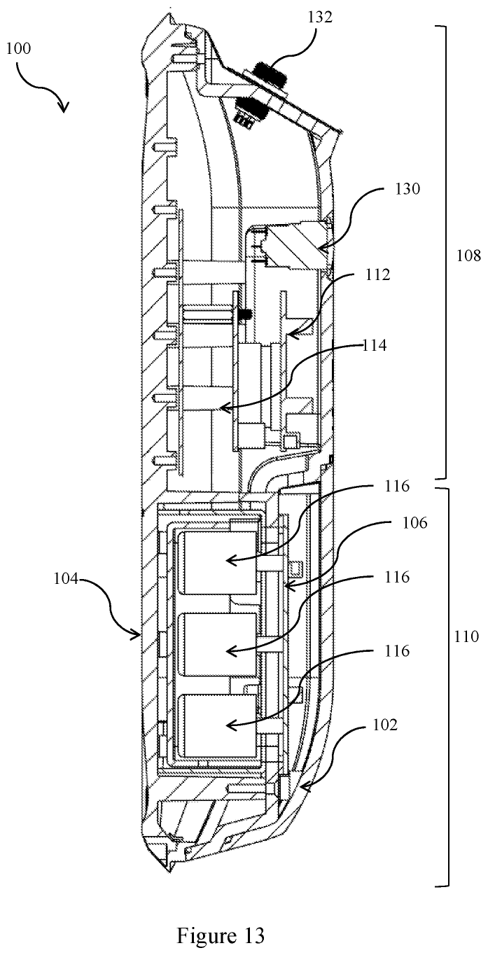

In FIG. 13, the housing 100 may include a power switch 130 that located on the back mounting portion 102 proximate to the location of the control module 112, and the electrical power port and/or the network communication port 132 may be arranged to be located on the back mounting portion 102 proximate to a top end of the housing 100.

In an embodiment, the control module 112 may include at least one Printed Circuit Board Assembly (PBCA) with a number of conventional electrical components, where the PBCA is understood to be a type of programmable device. The components may be mounted using through-hole or surface mount technology may include a microcontroller, accelerometer, Serial Peripheral Interface socket, at least one radio socket for a radio module, sensor input/output (I/O), crystal oscillator, solar or battery power socket, LED devices, On/Off switch, switch watchdog, mini-USB socket and a LED device associated with the USB socket. For example, the PCBA may be a Libeium WaspMote. Alternatively, the PCBA may be a Raspberry Pi computer. In a further example, the PCBA may be a BeagleBone Green single board computer, or the PCBA may include an Arduino microcontroller or another open source single board computer or microcontroller. The PCBA may also include one or more additional PCBAs 162, stacked on top of the first PCBA, which expands the functionality of the control module 112. The additional PCBAs may also be referred to as a shield or breadboard and may include further components or modules.

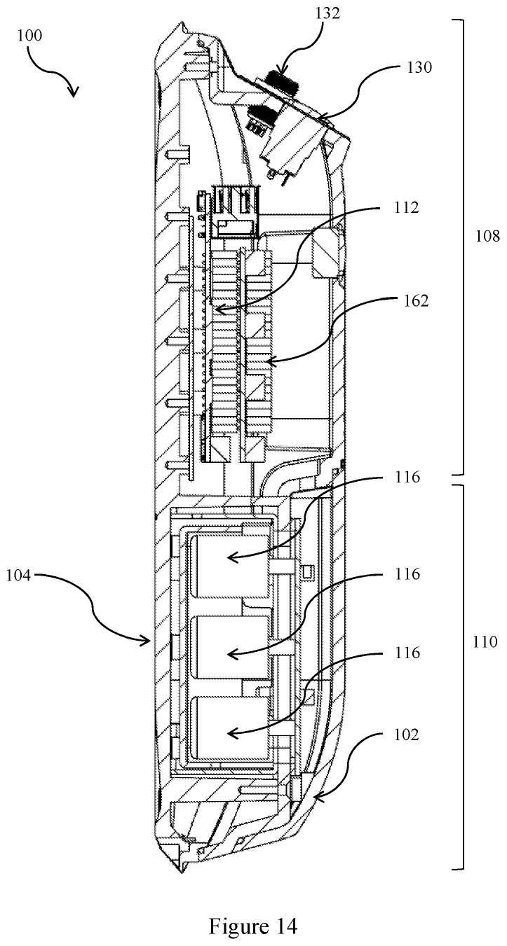

Further, in reference to FIGS. 13 and 14, the location of the power switch 130 may vary. For example, due to the size of the control module 112, the accommodation of additional power sources or other constraints, the power switch 130 may be moved to locate between the electrical power port and/or the network communication port 132.

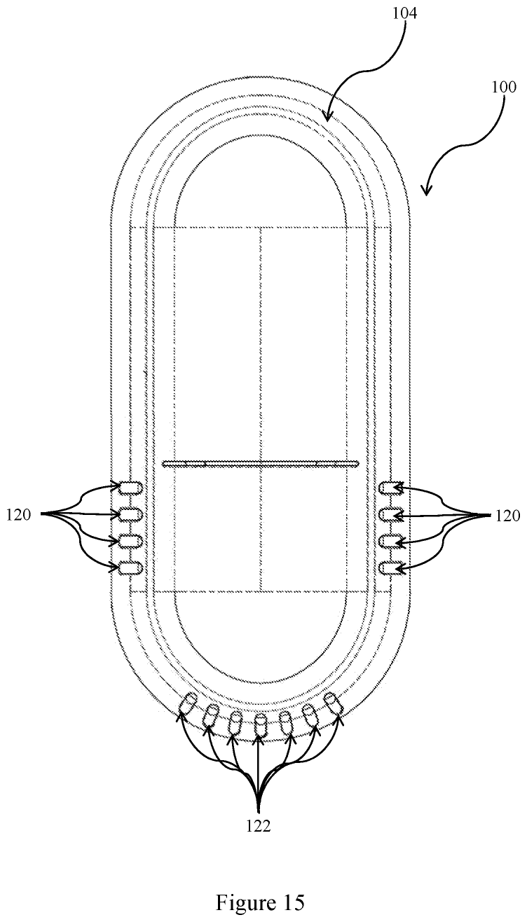

In an embodiment, the number of primary or secondary vents may vary. In a previous example shown in FIG. 4, the cover 104 includes four primary vents 120 on each side and three secondary vents 122 on the bottom. In another example shown in FIG. 15, the cover 104 includes four primary vents 120 on each side of the cover 104, and seven secondary vents 122 on the bottom. Each of the primary vents 120 and secondary vents 122 include a vent cover 124 as described in paragraph [0129]. Such an arrangement may provided where the housing 100 is subject to a high level of rain or water such that additional drainage may be required. By ensuring that there are sufficient secondary vents 122, this ensures that the housing 100 is not flooded and prevents ingress of water near the sensor array 106 housed in the second portion 110.

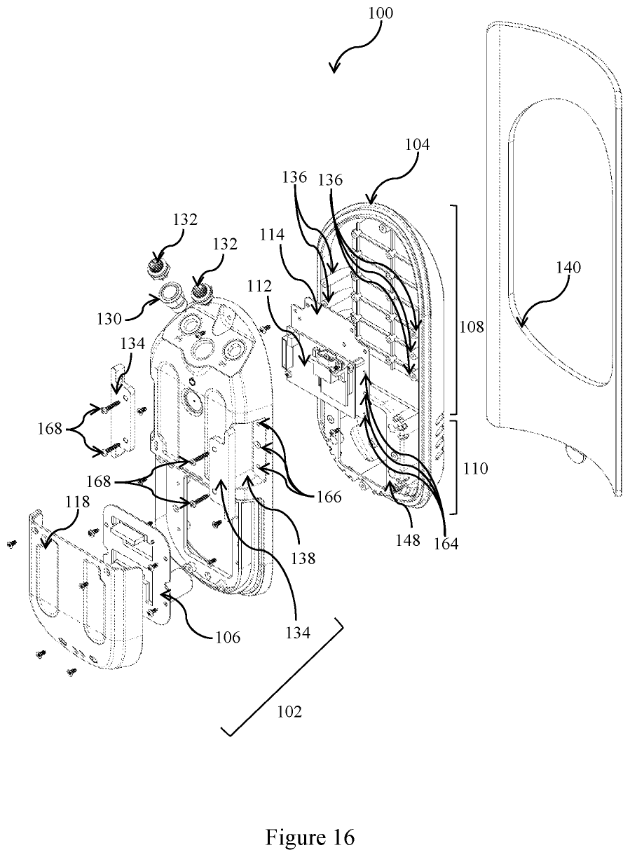

Referring to FIG. 16, an alternate embodiment of the housing 100 is provided. As can be seen, the cover is engagable with the boundary 140 of a surface. The boundary 140 is arranged to locate between cover 104 and the mounting plate 102. The cover 104 is attached to the mounting plate 102 via the first attachment portions 134 being attached to the second attachment portions 136 via the mounting plate 102. The mounting plate 102 includes the power switch 130 and the one or more electrical ports 132. Further, the labyrinth portion 146 is provided to house the sensor array 106 in the second portion 110, which is accessible via the access hatch 118.

In the embodiment, the control module 112 may be arranged to be connected to the mounting plate 102 instead of being mounted to the cover 104. In other words, the control module apertures 164 align with the recess apertures 166 so that fasteners 168 are arranged to pass through the first connecting portion 134, through both sets of apertures 164 and 166, and connect the control module 112 to the mounting plate 102. Once the cover 104 has been arranged on the outside side of the boundary 104 from the mounting plate 102, the fasteners 168 are received and engage with the second attachment portion 136, which mounts the housing to the surface. This arrangement provides a design that is easier to manufacture and a more efficient process of mounting the housing 100 to the boundary 140 of the surface.

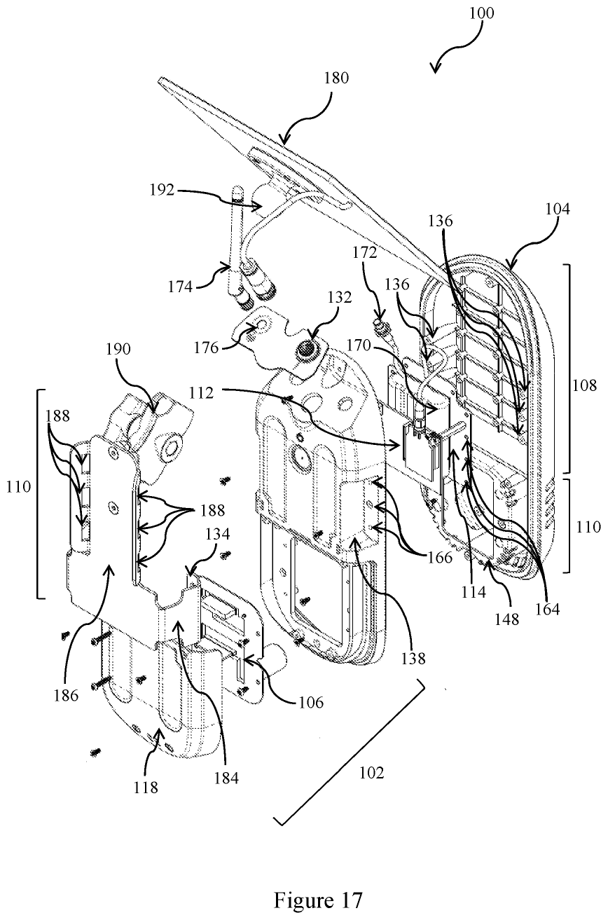

Referring to FIG. 17, an alternate embodiment may be provided, where the embodiment is arranged to be mounted to the surface of a pole, where the surface does not have an aperture or power source provided. In the alternate embodiment, the cover 104 is attached to the mounting plate by means of the first attachment portions 134 being attached to the second attachment portions 136 via the mounting plate 102. Further, the labyrinth portion 146 is provided to house the sensor array 106 in the second portion 110, which is accessible via the access hatch 118.

The control module 112 may include a rechargeable power supply, such as a battery 170. The battery 170 may be connected via cable to electrical connector 172. Further, the housing 100 may include antenna 174 that is arranged to connect to the control module via a cabled connection (not shown) passing through port 176. Antenna 174 may be arranged to enable a wireless network connection.

Electrical connector 172 is arranged to connect with the one or more electrical ports 132, which is in turn in connection with connector 178. Connector 178 may be formed to connect and transmit power from a solar cell arrangement 180 to the battery 170. This enables operation of the control module 112 and the sensor array 106, when the housing is mounted to a surface without a connection to a pre-existing power source. As such, the embodiment is capable to mounting to surfaces in remote locations or being retrofitted to pre-existing surfaces without power and a network connection.

Further, the control module 112 may be arranged to be connected to the mounting plate 102 instead of being mounted to the cover 104 in a similar fashion to what is described in paragraph [0150]. In other words, the control module apertures 164 align with the recess apertures 166 so that fasteners 168 are arranged to pass through the first connecting portion 134, through both sets of apertures 164 and 166, and connect the control module 112 to the mounting plate 102. However, the first attachment portions 134 may further include a fitting portion 182 that is arranged to sit against a surface. The fitting portion 182 may include two attachment portion arms 184, (only one is visible) where each attachment portion arm 184 is connected to the respective first attachment portion. The attachment portion arms 184 are arranged to extend outwards away a fitting portion 186. The fitting portion 186 may be elongate shaped and formed with a concave face to sit tightly against the curved surface of the pole.

The fitting portion 186 may be arranged to include a plurality of guides 188 that are arranged to retain a plurality of straps (not shown), where the straps are arranged to wrap around the circumference of the pole and hold the mounting body 182 tightly against the surface of the pole. That is, the plurality of straps and the mounting body 182 enable the housing 100 to be mounted to the pole.

Moreover, the top of the mounting body 182 may include a socket portion 190 that is arranged to received and retain a corresponding ball portion 192 that is provided to the underside of the solar panel arrangement 180 so that the solar panel arrangement 180 is connected to the mounting body 182 via a ball joint. This enables the position and solar orientation of the solar panel arrangement 180 with respect to the mounting body 182.

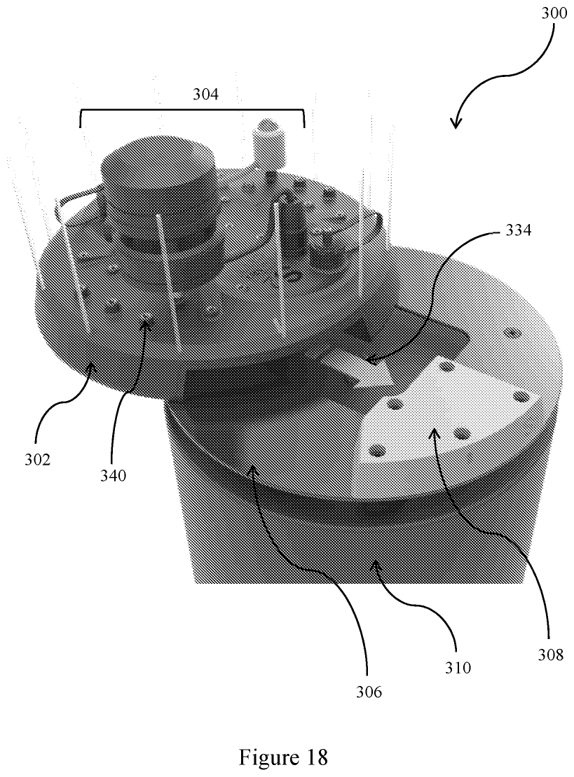

Referring to FIG. 18, an embodiment of a housing for a sensor array is provided. As shown, the housing 300 includes a head portion 302 including a sensor array 304, and a mounting plate 306 including an engagement portion 308. The mounting plate 306 may be mounted to a surface 310, where the surface 310 includes access to a supply of power and a network connection. The mounting plate 306 may be in connection in with the engagement portion 308. The engagement portion 308 may be removably attachable to the head portion 302 and enable the supply of power and/or an exchange of data through the network connection between the sensor array 304 and the surface 310.

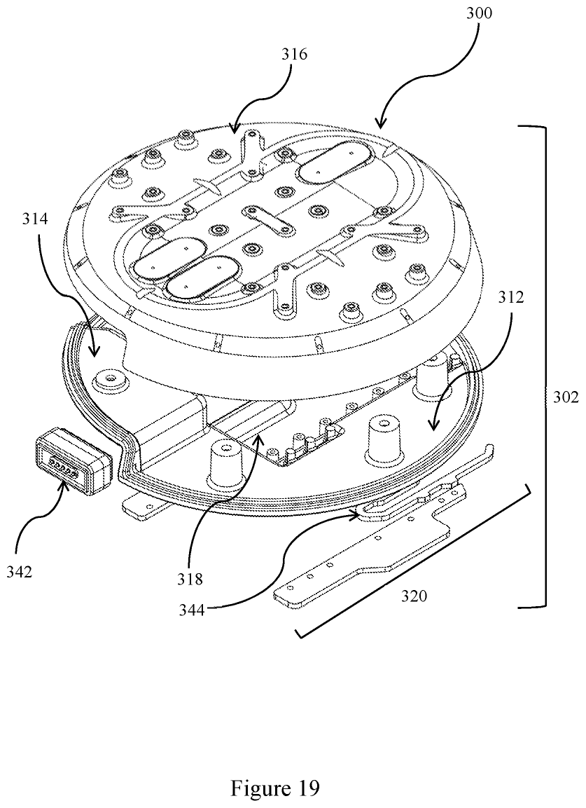

Referring to FIG. 19, an embodiment is provided including the head portion 302. The head portion 302 may include a base 312. The base 312 may be substantially planar to lay flat against the mounting plate 306, which may also be substantially planar. A portion of the base 312 may be shaped to engage with the engagement portion 308. As such, the base 312 may include a step portion 314, which is complementarily shaped and sized to engage with the engagement portion 308, which protrudes upwards from the mounting plate 306. The step portion 314 and the engagement portion 308 are discussed in further detail later in the description.

The head portion 302 may also include a cover 316, wherein the base 312 of the head portion 302 may be connected to the cover 316. The cover 316 and the head portion 302 may be shaped to form an internal cavity 318 within the head portion 302. As such, the cover 316 may be shaped to form a generally convex profile and be connected to the base 312 at the boundary of the convex shape.

In an embodiment, the head portion 302, mounting plate, 306, base 312 and cover 316 are circularly shaped. However, the circular embodiment is merely provided to assist the person skilled in the art in understanding the invention. As such, the head portion 302, base 312 and cover 316 may be of a variety of shapes including, square, rectangular, ellipse, polygon, parallelogram or any shape suitable to be mounted on the surface 310.

In an embodiment, the internal cavity 318 formed by the cover 316 and the base 312 may include a control module (not shown), where the control module may be provided as described earlier in the specification with reference to the control module 112 as described at [0114], [0146] and other locations within the specification.

In an embodiment, the head portion 302 may be waterproof. In an embodiment, the head portion 302 may also be hermetically sealed. As such, the housing 300 may include chemical or mechanical sealants that enable the head portion 302 to prevent the ingress of water and/or air. The housing 300 may include various chemical or mechanical sealants proximate to the perimeter of the head portion 302, such as but not limited to epoxy resin sealant, natural or synthetic O-ring, polytetrafluoroethylene tape or resin, or other similar methods of creating a waterproof seal. The head portion 302 may be waterproof or airtight to a specific known standard, for example to IP65 or IP66 enclosure waterproof ratings.

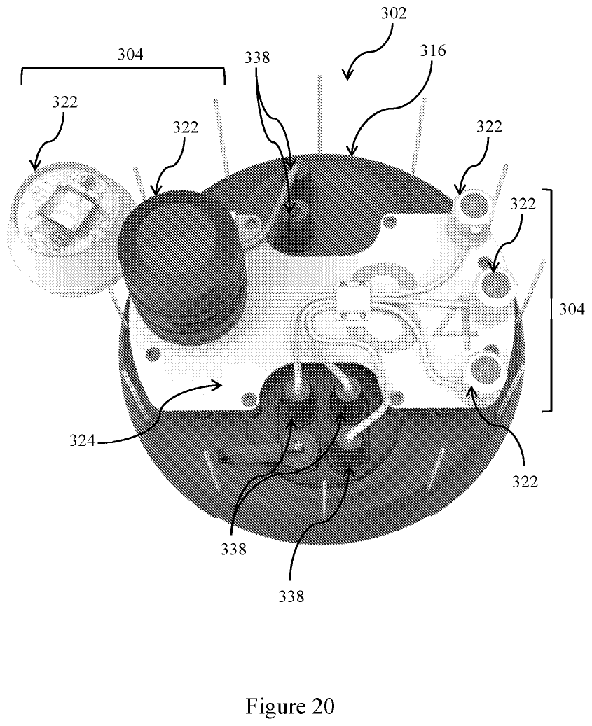

Referring to FIG. 20, an embodiment is provided wherein; the cover 316 includes the sensor array 304, where the sensor array 304 includes one or more sensors 322. The one or more sensors 322 in the sensor array 304 may be directed to sensing the levels or concentrations of a variety of parameters or environmental conditions. The parameters may include one or more of Ultra Violet (UV) light, solar irradiance, radiation, the effect of the quantum state of another system on itself, luminosity, photons, acoustic resonance, wind strength and direction, rainfall, temperature, humidity, air pressure, distance of stationary or passing objects from radar, ultrasonic, passive infrared readings, radiation, Radio-frequency identification data, sound level, acoustic pressure, Carbon Monoxide, Carbon Dioxide, Molecular Oxygen, Ozone, Nitric Oxide, Nitric Dioxide, Sulfur Dioxide, Ammonia, Methane and other combustible gases, Molecular Hydrogen, Hydrogen Sulfide, Hydrogen Chloride, Hydrogen Cyanide, Phosphine, Ethylene Oxide, Chlorine, Isobutane, Ethanol, Toluene, Volatile Organic Compounds, Hydrocarbons, or Particle Matter, such as dust or lead particulates. As such, each of the one or more sensors 322 may be directed to sensing the levels or concentrations of a single of the above parameters or one or more of the above parameters.

Various sensors may be housed within the housing 300 or mounted to the housing 300 which are capable of sensing the levels or concentrations of the variety of parameters. For example, the sensors may include, but are not limited to a temperature sensor, hygrometer, air pressure sensor, radar, passive infrared sensor, gigameter, radio-frequency sensor, sound level meter, light or photometric sensor, quantum sensor, pyranometer, photon detector, actinometer. Moreover, the housing 300 may also include a still or video capture device, such as a camera or a LIDAR sensor mounted to the head portion 302, which provides a data stream, in the form of at least one digital data set that is capable of being transferred by the control module through the network connection, which is discussed in further detail below.

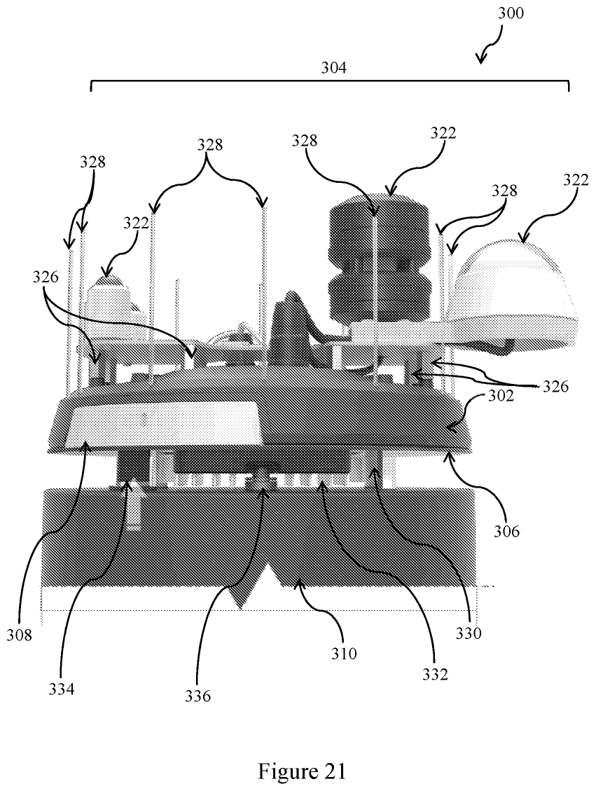

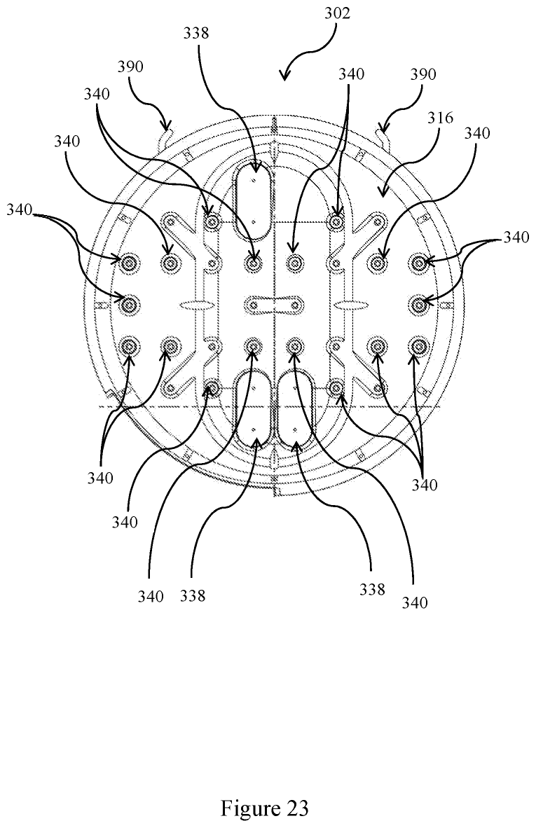

Referring to FIG. 18, an embodiment of the sensor array 304 is provided where the sensor array 304 may be directly mounted on the cover 316. Alternatively, the sensor array 304 may include a sensor array plate 324 as shown in FIG. 20. The sensor array plate 324 may be formed to enable the one or more sensors 322 of the sensor array 304 to be mounted to the sensor array plate 324, which is mounted to the cover 316. Referring to FIGS. 19 and 21 the sensor array plate 324 may include a plurality of legs 326, which mount the sensor array plate 324 to the cover 316. The plurality of legs 326 may be arranged to engage with each of the plurality of leg sockets 340 (shown in FIG. 23), which are described later in the specification. The plurality of legs 326 may extend through the sensor array plate 324 such that the plurality of legs 326 can be accessed, tightened, loosened or released by a user to enable separation of the sensor array plate 324 (including the sensor array 304) from the cover 316. The sensor array plate 324 may be a substantially planar platform, which enables the one or more sensors 322 to be mounted substantially parallel to the top face of the surface, despite the concave shaped profile of the cover 316. The sensor plate array 324 may also enable replacing an entire sensor array 304 instead of changing out the one or more sensors 322 individually.

Referring to FIG. 21, an embodiment is provided where the housing 300 further includes protective features. The protective features are arranged to protect and shield the sensor array from damaged caused by the environment or animals. For example, the cover 316 may include a plurality of bird spikes 328 arranged to extend upwards from the cover 316 to prevent birds from landing and nesting on the housing 300. Although not shown in the Figures, the housing 300 may also include a shield (not shown) for delicate components, netting or mesh (not shown) to prevent animals or insects from nesting in the housing 300, overhanging collars (not shown) extending outwards from the housing 300 to protect against climbing animals and other such means of protection as would be understood by the skilled addressee to be within the scope of the invention as so described and defined in the claims.

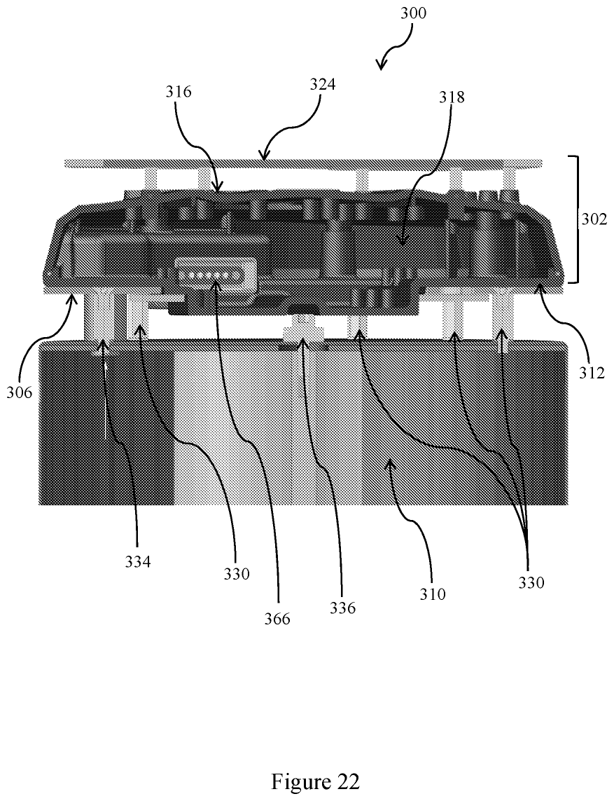

Referring to FIGS. 21 and 22, a further embodiment is provided where the mounting plate 306 may be spaced above the surface 310 by means of one or more elongate members 330, which are arranged to extend between and engage with the mounting plate 306 and the surface 310. The mounting plate 306 may further include a heat sink 332 provided proximate to the control module and/or a power source such as a battery, that is retained in the internal cavity 318 of the head portion 302. The heat sink 332 is arranged to transfer heat generated from the control module and/or a power source to the air in the space between the mounting plate 306 and the surface 310 as defined by the elongate members 330. As such, the mounting plate 306 may also include a power conduit 334, which extends upwards from the surface 310, into the mounting plate 306, and into the engagement portion 308. The power conduit 334 may also include a wired data network connection.

The mounting plate 306 may also include a mounting fastener 336, which extends upwards from the surface 310 and is slidably attachable to the base 312. The mounting fastener 336 may be arranged be fixed to the surface 310 at a first end or along its length and be slidably engagable with the base 312 of the housing 100 at a second end. The mounting fastener 336 may assist in providing extra support to keep the housing 100 engaged with the surface 310 and to assist with alignment of the housing with the mounting plate 306 and the engagement portion 308.

Referring to FIG. 23, an embodiment is provided wherein the cover 316 includes an array of sensor sockets 338 which are formed to engage with corresponding plugs and electrical conduit (shown in FIGS. 20 and 21) in connection with the one or more sensors 322 included in the sensor array 304. Each of the sensor sockets 338 may include a hinged cover that is biased to cover the sensor sockets 338 and protect them from the elements when each of the sensor sockets 338 are not engaged with a corresponding sensor plug.

In a further embodiment, the cover 316 may include a plurality of leg sockets 340 arranged to engage a plurality of legs provided to the sensor array plate 324. The plurality of leg sockets 340 may be provided to the concave shaped top surface of the cover 316. The plurality of leg sockets 340 may be arranged on the cover 316 in a grid pattern of orthogonal rows and columns to enable the sensor array plate 324 to be attached to the cover 316 in a variety of positions or arrangements. Alternatively, the leg sockets 340 may instead be arranged as sensor sockets that are arranged to engage the sensors directly so that the sensors are directly mounted on the cover 316.

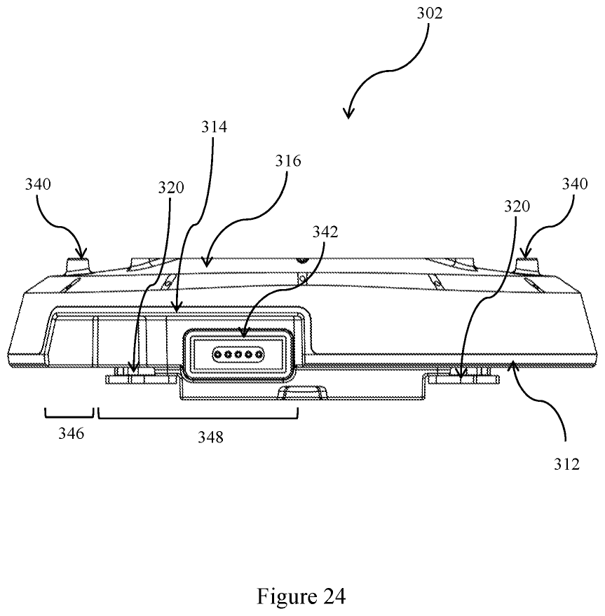

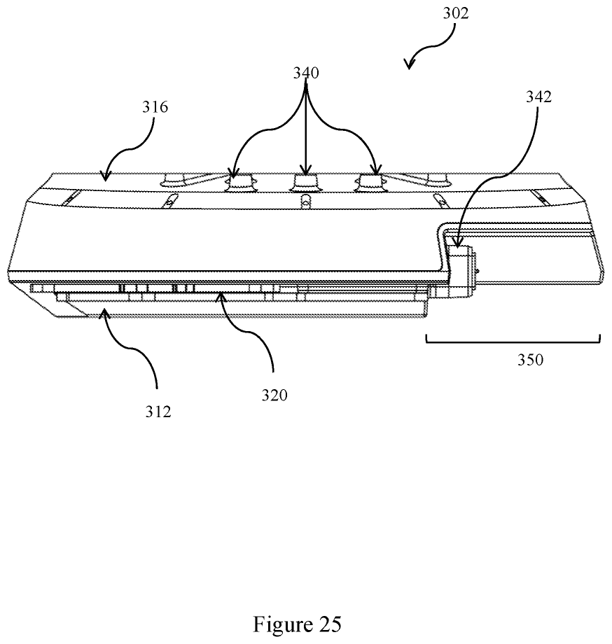

Referring to FIGS. 24 and 25, the features of the head portion 302 are provided in further detail. An embodiment of the housing 300 is provided, wherein the head portion 302 includes the step portion 314, which is complementarily sized and shaped to engage with the engagement portion 308, which protrudes upwards from the mounting plate 306. The head portion 302 may also include a connector 342 that is arranged to engage both the head portion 302 and the engagement portion 308. The head portion 312 may also include at least one attachment mechanism 320, which is discussed in further detail later in the specification.

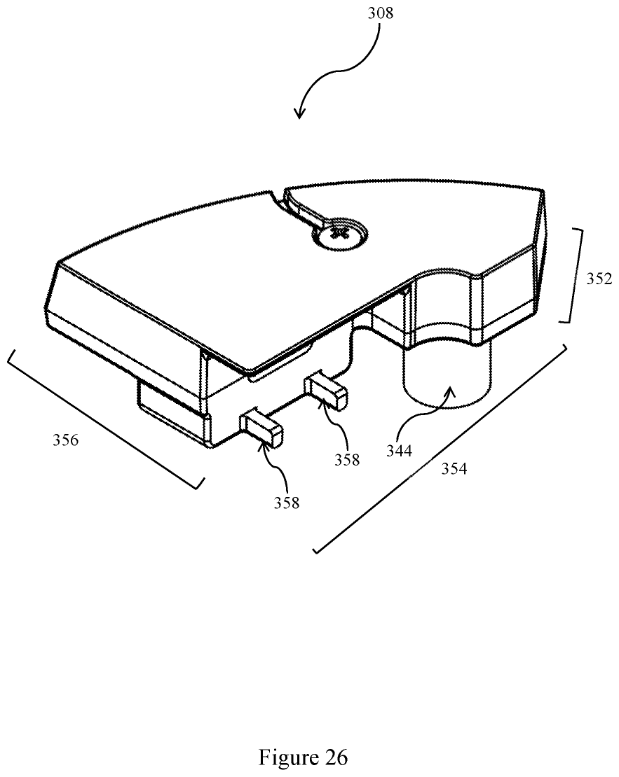

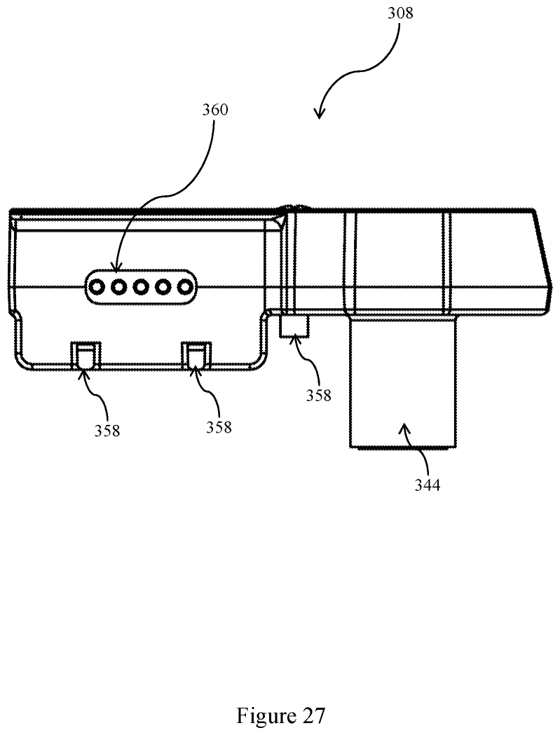

Referring also to FIGS. 26 and 27, an embodiment is provided wherein the housing 100 includes the engagement potion 308. The engagement portion 308 is connected to the mounting plate 306 and is arranged to slidingly engage with the head portion 302 so that the head portion 302 is mounted to the mounting plate 306 on the top of the surface 310. The step portion 314 and the engagement portion 308 are complementary sized and shaped with respect to one another in at least one axis. That is, the at least one face of the step portion 314 includes a surface that is shaped to engage with a complementarily shaped face of the engagement portion 308. Moreover, the respective faces of the step portion 314 and the engagement portion 308 may be shaped to engage and interlock with one another, so that once so engaged, may be only unengaged by disconnecting the step portion 314 from the engagement portion 308 in a single direction.

For example, in the embodiment shown in FIGS. 24 to 27, the recess 314 is a complementary shape relative to the engagement portion 308. The engaging faces 346, 348 and 350 of the step portion 314 each respecting engage with engaging faces 352, 354, and 356 of the engagement portion 304. Moreover, engaging face 354 may include one or more prongs 358 which are receivable within corresponding recesses provided to the engaging face 348 of the step portion 314. However, as would be understood by the person skilled in the art, the shape of the step portion 314 and the engagement portion 308 provided in this example are not to be taken as a limitation. The example is merely provided to assist the understanding of the skilled addressee, and as such, the skilled addressee would understand that variations in the shape of the engagement faces, the number and orientation of the engagement faces and the presence of further features such as prongs, flanges, lips, recesses and protrusions that are complementarily provided to each of the step portion 314 and the engagement portion 308 to enable them to engage and optionally interlock are within the scope of the claims.

Referring to FIG. 27, an embodiment is provided wherein the engagement portion 308 includes a connector pin receiver 360 provided to at least one of the engaging faces 352, 354, and 356 of the engagement portion 308. Moreover, the step portion 314 of the head portion 302 may also include a connector pin receiver 366 (best shown in FIG. 22), which is provided to at least one of the engaging faces 346, 348 and 350 of the step portion 314.

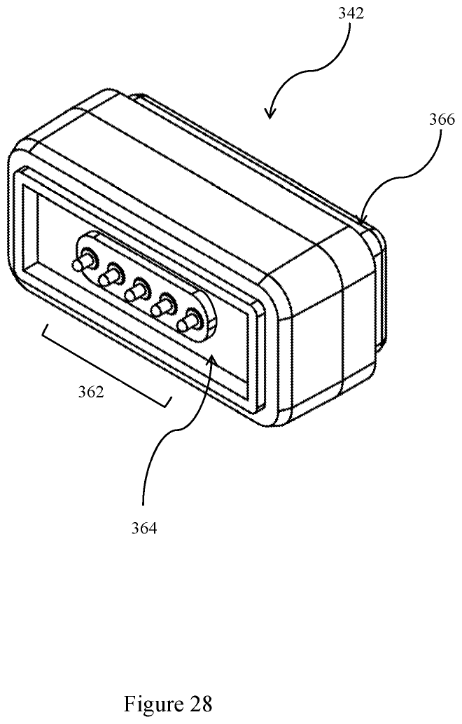

Referring to FIG. 28, the connector 342 includes a first set of pins 362 on a first side 364 and a second set of pins on a second side (not shown). The connector pin receiver 360 provided to the engagement portion 308 and the connector pin receiver 366 provided to the step portion 314 is arranged to receive the first set of pins 362 and the second set of pins, respectively.

Accordingly, when the engagement portion 308 and the step portion 314 are engaged, the connector 342 is engaged between them such that the connector 342 enables an exchange of power from the surface 310 to the mounting portion 306 through the power conduit 334, into the engagement portion 308, through the connector 342 and into the head portion housing which includes the control module and the sensor array 304. As such, the first set of pins 362 and the second set of pins are connected. Further, the connector 342 may also be arranged to enable the transmission of data from the control module via the network connection. The connector enables the transmission of data and power only when the head portion 302 is engaged with the mounting plate 306 and the engagement portion 308. The connector 342 also ensures that the head portion 302 may remain water and/or airtight.

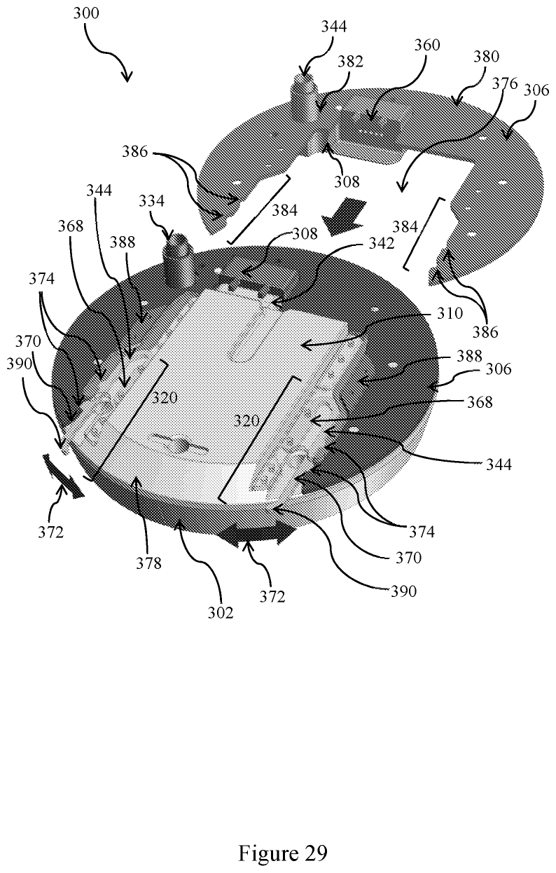

Referring to FIG. 29, an embodiment is provided wherein the mounting plate 306 is shaped to engage with the bottom face of the base 312. The mounting plate 306 may be shaped to engage with the at least one attachment mechanism 320 provided to the head portion 302. In an embodiment, the at least one attachment mechanism 320 includes two arms 344, where the two arms 344 are shaped to form a two substantially parallel portions joined together by a “U” shaped section, wherein one of the two substantially parallel portions may be fixed 368 to the bottom face of the base 312 and the other end 370 is freely disposed and not connected to the head portion 302. That is, the two arms 344 may be formed such that the “U” shape enables the free end 370 of the two arms 344 to flex and move towards and away from the fixed end 368, as indicated by the arrows 372. The two arms 344 may also include one or more ridges 374, which protrude from the outer edges of the free end 370 of the two arms 344.

The mounting plate 306 may be shaped in various ways to engage with the bottom face of the base 312. The mounting plate 306 may include a hole, “cut-out” or bite portion 376, which may be shaped to receive a correspondingly shaped protrusion 378 on the bottom face of the base 312 (this is also shown in FIG. 21). The mounting plate 306 may also include a further bite portion 380 shaped to receive the engagement portion 308, and an aperture portion 382 capable of receiving the power conduit 334.

The bite portion 370 may also include a two arm engagement portions 384 that are capable of slidably receiving the two arms 344. The two arm engagement portions 384 may include one or more notches 386 that are shaped to receive the one or more ridges 374. Due to the ability of the free end 370 of the two arms 344 to flex towards and away from the fixed ends 368, each of the two arms 344 and each of the two arm engagement portions 384 are arranged to respectively engage with one another in a snap fit arrangement. When the two arms 344 and the two arm engagement portions 384 are engaged, the notches 386 and the ridges 374 are also engaged and maintain the arrangement in an engaged position.

The mounting plate 306 may further includes one or more spacers 388 that are provided on the edge of bite portion 376. The spacers 388 act to guide the free end 370 of each of the two arms 344 into the snap fit arrangement with the two arm engagement portions 384, and act to support the two arms 344 in when retained in the snap fit arrangement.

In an embodiment, each of the free ends 370 of the two arms 344 may include a lever 390, which is arranged to protrude the free end 370 at an angle that is offset from the axis of the length of the arm 344. The levers 390 may be arranged to enable each of the free ends 370 of the two arms 344 to be flexed or moved towards the fixed ends 368 to enable the two arms 344 to be disengaged from the two arm engagement portions 384 and out of the snap fit engagement. As such, the snap fit arrangement enables the head portion 302 to be removably attached to the mounting portion 306.

In an embodiment, the sensor array 304 communicates at least one data set from the one or more sensors 322 to the control module housed inside the head portion 302. As such, the sensor array 304 may be in wired communication with the control module. The at least one data set may include at least one digital data set collected from the one or more sensors 322 in relation to the levels of any of the above described parameters. The sensor array 304 communicates at least one digital data set from the one or more sensors 322 to the control module.

Alternatively, the at least one data set may include at least one analogue data set collected from the one or more sensors 322 in relation to the levels of any of the above described parameters. In the case where the at least one data set collected from the one or more sensors 322 is an analogue data set, the control module is programed to perform at least one data conversion process on the at least one analogue data set received from the sensor array 304, wherein the at least one data conversion process may include converting the at least one analogue data set to at least one digital data set. For example, the control module may be programed to convert an analogue electrical current reading from the sensor array 304 to digital parameter measure. The conversion process of the data gathered by the sensors may be processed in a similar fashion to the conversion process as described in paragraph [0122].

In an embodiment, there is provided an alternate data collection and communication system similar to the data collection and communication system 200 described in paragraphs [0136] to [0139] and shown in FIG. 3. The alternate data collection and communication system includes a plurality of housings 300 as described above. That is, the data collection and communication system 200 may be modified to use housing 300 instead of housing 100 at each instance of the nodes indicated by 204. In another embodiment, the alternate data collection and communication system may include a combination of pluralities of housings 100 and housings 300 at any of the nodes 204.

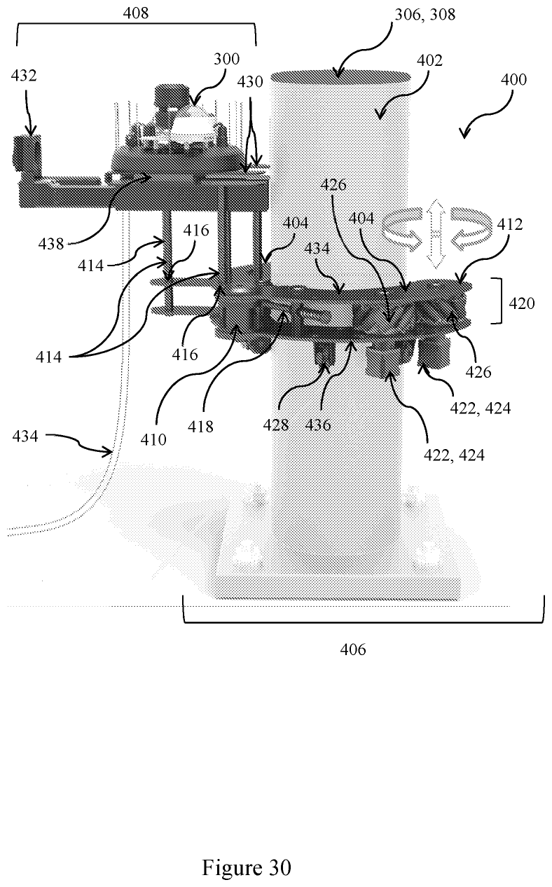

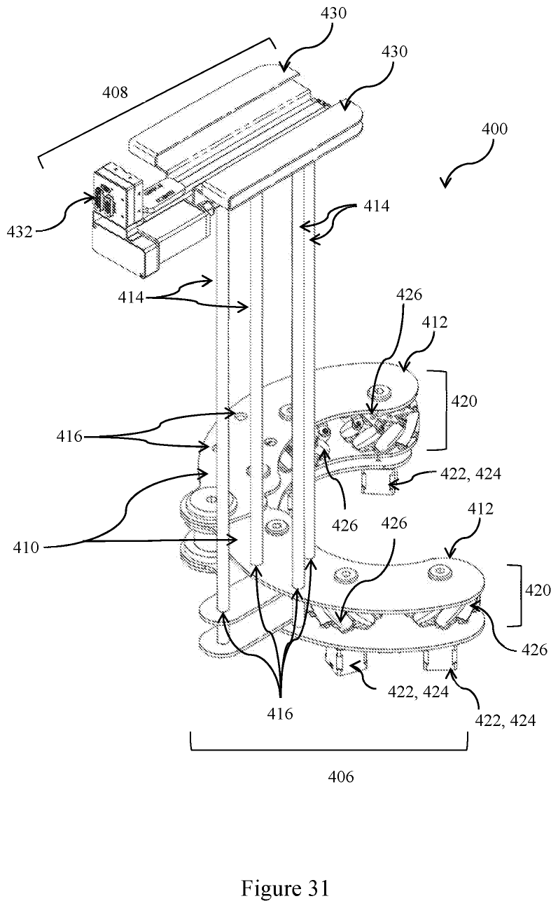

Referring to FIGS. 30 and 31, there is provided a deployment system 400, for deploying the housing 300 on a planar top of a vertical pole surface 402, wherein the planar top includes the mounting plate 306. The deployment system 400 includes, two arms 404 formed to removably engage around the circumference of the pole surface 402, at least one powertrain 406 for translating the deployment device 400 along the pole surface 402, and a deployment mechanism 408 for actuating the housing 300 into an engaged position with the mounting plate 306 and the engagement portion 308. Although the mounting plate 306 and the engagement portion 308 shown in a simplified form in these figures, the person skilled in the art would understand the arrangement of the mounting plate 306 and the engagement portion 308 on the top of the pole surface 402 as it has been previously described in the preceding paragraphs.

The deployment system 400 is capable of mounting a housing 300 to a surface, de-mounting a housing 300 to a surface. Further, the deployment system 400 is also arranged to engage with a cleaning attachment (not shown) for cleaning of the housing 300 when mounted on the surface. Moreover, the cleaning attachment may also be arranged to clean the surface 310 or other accessories provided to the surface 310, such as lighting system lenses. In respect of the embodiments of the deployment system 400, the surface is a vertical pole and the housing is mounted on the planar top of the pole, where the top of the pole includes the mounting plate 306 as described above.

The two arms 404 may be pivotally joined at a first end 410, which is proximate to the deployment mechanism 408. That is, each of the two arms 404 having a first end 410 and a second end 412. The two arms 404 are pivotally joined together at the respective first end 410, and may be joined or located proximate to each other at the respective second ends 412. The arms 404 may be joined to the deployment mechanism 408 by means of adjustable legs 414 at the first end 410. The adjustable legs 414 may be fixed to the underneath of the deployment mechanism 408 and receivable by apertures 416 provided at the first end 410 or along at least one of the arms 404. The apertures 416 and the adjustable legs 414 may both include corresponding threads that enable the length of the adjustable legs 414 to be adjusted by rotating the adjustable legs within the apertures 416 provided at the first end 410 along at least one of the arms 404. The two arms 404 may also include a locking mechanism 418 that fixes the two arms 404 in an engaged position with the pole surface 402. It would be understood that on release of the locking mechanism 418, the two arms 404 would be free to pivot with respect to one another such that the two arms 404 may be disengaged with the pole surface 402.

In a further embodiment, the two arms 404 include an upper frame 434 and a lower frame 436 that together form a chassis 420 that supports the powertrain 406. The powertrain 406 may also include at least one motor 422, at least one motor controller 424 and at least one wheel 426. The at least one motor controller 424 may be arranged to be integrated with the at least one motor 422 as shown in FIG. 30. Alternatively, the at least one motor controller 424 may be arranged to control the operation of more than one motor and may be located separately from the at least one motor 422. The at least one motor 422 may be an electric motor, such as but not limited to an AC or DC brushless motor, a direct drive motor, linear motor, server motor, or stepper motor. Moreover, the at least one wheel may include a conventional wheel, caterpillar track, sphere, threaded wheel base (screw-propelled), pedrail wheel, or an Omni-directional wheel, or a combination of said wheels that enable both movement up and down and around the circumference of the pole surface 402. Moreover, the chassis 420 may also include at least one guiding wheel 428, which tracks along the pole surface 402, provides a stabilising effect, and supports the chassis 420 and the deployment system 400 as a whole.

In another embodiment, the deployment mechanism 408 may include a track 430 that is formed enable the head portion 302 to be slidingly engaged with the mounting plate 306 via the two arms 344 and the two arm engagement portions 384. The track 430 may include two substantially parallel slides that are slidingly engaged with the bottom face of the base 312. For example, the each of the two substantially parallel slides may be arranged to engage with each side of the protrusion 378. The deployment mechanism 408 may also include a motorised platform 438 that is arranged to engage with the bottom of the head portion 302 and push or retract the head portion 302 into engagement or out of engagement with the mounting plate 306 and the engagement portion 308. Alternatively, the deployment mechanism 408 may include a deployment arm (not shown) which is arranged to move the head portion along the track and into engagement with the mounting plate 306.

Moreover, the ends of the track 430 proximate to the pole surface 402 may also include two disengagement members (not shown) that are shaped to disengage the housing from the mounting plate. For example, the two disengagement members may be shaped to engage with the levers 390 and apply a force to each of them such that they flex towards the fixed end 368 and disengage the ridges 374 from the notches 386, thus disengaging the two arms 344 from the two arm engagement portions 384.

In an embodiment, the deployment mechanism 408 may also include a camera 432. The camera 432 may be arranged to provide a feed of visual information to assist in the operation of the deployment system 400. The deployment system 400 may include a cable 434 to provide power, communication, or additional control. A user may operate the deployment system 400, wherein the cable 434 may be connected to a control system and interface under the control of the user who uses the control system and interface to operate the deployment system 400. For example, the control system and interface may include a computer connected to cable 434, where the computer runs software that communicates with the at least one motor controller 424 that controls the at least one motor 422. For example, the software may instruct the at least one 424 to control the electrical power provided to the at least one motor 422 or operate the motorised platform 438. The interface may further include a hand held controller and software drivers that the user uses to operate the deployment system 400. Alternatively, the control system and interface under the control of the user may communicate with the deployment system wirelessly, such as by means of Wi-Fi or radio.

In an embodiment, the deployment mechanism 408 may include a cleaning attachment (not shown) which uses water or other cleaning fluids to clean the housing 300 when mounted on the surface. The cleaning attachment may include a nozzle for directing the water towards the housing and the nozzle may be in fluid connection with a water repository and/or the cable 354, which may be configured to include a supply of water to the deployment system 400. The nozzle may be arranged to clean the entire housing 300 from a fixed position on the cleaning attachment, or may include an articulated arm for controlling the direction of the water provided by the nozzle, wherein the articulated arm is under the control of the user by means of the control system and interface. Moreover, the cleaning attachment may also be arranged to clean the surface 310 or other accessories provided to the surface 310, such as visual system or lighting system lenses. The cleaning attachment may be removably attachable to the deployment system 400 by means of replacing the deployment mechanism 408 with the cleaning attachment by disconnecting the adjustable legs 414 from the at least one powertrain 406. Alternatively, the cleaning attachment may be integrally formed with a separate powertrain 406 so that two devices may be used, one for deployment and one for cleaning.

### ADVANTAGES

The embodiments described herein provide a novel means of housing and mounting sensor arrays. The first aspect of the present invention enables sensitive electrical equipment, such as sensors, to be housed in a manner that protects them from the environment. In particular, the first aspect also enables the sensors to have unimpeded access to air flow to gain data readings by means of the air pathway, where the air pathway is formed to prevent the ingress of water. By housing the sensor array in this fashion, the expensive sensors are likely to operate for a longer period of time and be less likely to introduce errors in the data due to damage and environmental stress. Moreover, the portion of the housing containing the control module is hermitically sealed, which reduces the likelihood of damage by water or insect infestation.

The housing is designed in a way to be mountable to a variety of surfaces and at any orientation. As such, further opportunities for data collection are provided due to the flexibility of mounting options provided by the housing. Furthermore, the housing is designed to mount in a way that does not permit tampering or vandalism. As such, the housing may be mounted in urban areas to collect data on people or provide help or assistance to people.

Moreover, the housing is designed with maintainability in mind by providing access hatches to access and swap out sensors so that faults can be repaired faster and housings can be refitted with a variety of sensor arrays over time providing additional functionality. Moreover, the embodiments described provide a housing that is capable of being retro-fitted to existing poles or structures by means of the mounting body. The inclusion of a solar cell arrangement power and antenna for wireless connection to a network enables placement of the housing in remote locations or locations without a wired power and network connection.

The second aspect and the third aspect overcome the issues faced by the art in providing a safer, faster and easier alterative to having a skilled tradesperson to climb or be lifted up to the high place in order to place the sensors on the top of poles or other high places. The second and third aspects provide that the tradesperson should only have to ascend a single time to mount the mounting plate on the top of the pole and the deployment system is capable of mounting the head portion onto the mounting plate such that the housing is mounted.

Further the deployment system provides the user the ability to access, clean, replace and maintain the housing when standing safely on the ground. Further, the deployment system reduces the need for lifting devices to lift the tradesperson to the top of the pole, such as an aerial work platform (AWP) or cherry picker. Accordingly, without the need for large and dangerous lifting devices, the present invention reduces the delays caused to vehicular traffic and foot traffic and the need for stringent traffic control during the installation of sensors on high places. As such, these aspects open new opportunities for data collection in locations that would have otherwise been too difficult to access.

1. A housing for a sensor array comprising:
a mounting plate for mounting the housing to a surface;
a cover attachable to the mounting plate, where the mounting plate and the cover are shaped to form an internal cavity within the housing;
the sensor array being housed within the internal cavity; and
at least one air pathway in connection with the sensor array to enable air to pass from outside the housing to the sensor array.

2. The housing in accordance with claim 1, wherein the air pathway is formed to enable the ingress and egress of air into the housing proximate to the sensor array.

3. The housing in accordance with claim 1, wherein the air pathway is formed to prevent ingress of one or more contaminants to the sensor array and wherein the one or more contaminants include water.

4. (canceled)

5. The housing in accordance with claim 1, wherein the housing is arranged so that the internal cavity is divided into a first portion and a second portion, wherein the first portion includes a control module.

6. (canceled)

7. The housing in accordance with claim 5, wherein the control module includes one or more of any of the following; a programmable device; a microcontroller; a network connection device; a power source; an internal sensor; a serial port; and a universal serial bus receptacle.

8. The housing in accordance with claim 5, wherein the control module is attached to a universal attachment plate contained within the first portion.

9. The housing in accordance with claim 5, wherein the first portion is waterproof.

10. The housing in accordance with claim 5, wherein the second portion includes the sensor array.

11. (canceled)

12. The housing in accordance with claim 1, wherein the sensor array includes one or more sensors wherein the one or more sensors in the sensor array are directed to sensing the levels of one of the following parameters; temperature; humidity; air pressure; distance of stationary or passing objects from radar, ultrasonic, passive infrared readings; radiation; radio-frequency identification data; sound level; acoustic pressure; luminosity; Carbon Monoxide; Carbon Dioxide; Molecular Oxygen; Ozone; Nitric Oxide; Nitric Dioxide; Sulfur Dioxide; Ammonia; Methane and other combustible gases; Molecular Hydrogen; Hydrogen Sulfide; Hydrogen Chloride; Hydrogen Cyanide; Phosphine; Ethylene Oxide; Chlorine; Isobutane; Ethanol; Toluene; volatile organic compounds; hydrocarbons; particle matter.

13. The housing in accordance with claim 5, wherein the sensor array communicates at least one data set to the control module.

14. The housing in accordance with claim 13, wherein the at least one data set is at least one analogue data set.

15. The housing in accordance with claim 14, wherein the control module is programmed to perform at least one data conversion process on the at least one analogue data set received from the sensor array.

16. The housing in accordance with claim 15, wherein the at least one data conversion process includes converting the at least one analogue data set to at least one digital data set.

17. The housing in accordance with claim 5, wherein the air pathway is included in the second portion.

18. The housing in accordance with claim 17, wherein the second portion further includes a labyrinth portion that defines the shape of the air pathway.

19. The housing in accordance with claim 18, wherein the labyrinth portion includes an inner casing and an outer casing.

20. The housing in accordance with claim 19, wherein the inner casing is received within the outer casing such that one or more spaces between the inner casing and the outer casing define a shape of the air pathway.

21. The housing in accordance with claim 17, wherein the air pathway includes at least one section that is arranged to extend orthogonally relative to the direction that the force of gravity acts.

22. The housing in accordance with claim 17, wherein the air pathway includes one or more vents.

23. The housing in accordance with claim 18, wherein the labyrinth portion further includes at least one drainage pathway arranged to extend downwards from a first of the at least one vents to a second of the at least one vents.

24. The housing in accordance with claim 23, wherein the one or more vents include a vent cover.

25. The housing in accordance with claim 24, wherein the vent cover includes a portion of metal mesh.

26. The housing in accordance with claim 24, wherein the vent cover is insect resistant.

27. The housing in accordance with claim 24, wherein the vent cover is water resistant.

28. The housing in accordance with claim 1, wherein the surface includes an aperture that is complementarily shaped and sized to engage with the housing.

29. The housing in accordance with claim 28, wherein the aperture includes a boundary portion that is arranged to be engaged between the cover and a first attachment portion.

30. The housing in accordance with claim 29, wherein the cover includes a lip arranged to fit tightly against the boundary portion such that the place of joining between the cover and the boundary portion has no edge.

31. The housing in accordance with claim 1, wherein the housing further includes a mounting body arranged to connect the housing to a pole surface and retain a solar panel arrangement.

32-34. (canceled)

35. A data collection and communication system comprising, a plurality of housings according to claim 1, each housing including the control module, wherein each of the plurality of housings is in communication with one another via a data network.

36. The data collection and communication system in accordance with claim 35, wherein the data network further comprises at least one terminal that is programmed to compile, and analyse the at least one digital data set received from the control module provided to each of the plurality of housings.

37-59. (canceled)
